(19) United States
(12) Patent Application Publication
(10) Pub. No.: US 2026/0252963 A1
(43) Pub. Date: Aug. 27, 2026

(54) SYSTEM

(71) Applicant: SoftBank Group Corp., Tokyo (JP)

(72) Inventor: Yuki TAKIZAWA, Tokyo (JP)

(73) Assignee: SoftBank Group Corp., Tokyo (JP)

(21) Appl. No.: 19/541,449

(22) Filed: Feb. 17, 2026

(30) Foreign Application Priority Data
Feb. 21, 2025 (JP) 2025-027052

(51) Int. Cl. G06N 20/00; G06Q 10/40

(52) U.S. Cl. CPC G06N 20/00; G06Q 10/40

(57) ABSTRACT

The system according to the embodiment comprises a reception unit, an analysis unit, a proposal unit, and a simulation unit. The reception unit inputs a user's status. The analysis unit analyzes information input by the reception unit. The proposal unit proposes a target task based on information analyzed by the analysis unit. The simulation unit simulates a post-recovery state based on the target task proposed by the proposal unit.

### CROSS-REFERENCE TO RELATED APPLICATION

The present application claims priority to and incorporates by reference the entire contents of Japanese Patent Application No. 2025-027052 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there has been a problem in which patients undergoing long-term hospitalization or rehabilitation lose sight of their goals, making it difficult to find direction after recovery.

### SUMMARY OF THE INVENTION

The system according to the embodiment comprises a reception unit, an analysis unit, a proposal unit, and a simulation unit. The reception unit inputs a user's status. The analysis unit analyzes information input by the reception unit. The proposal unit proposes a target task based on information analyzed by the analysis unit. The simulation unit simulates a post-recovery state based on the target task proposed by the proposal unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

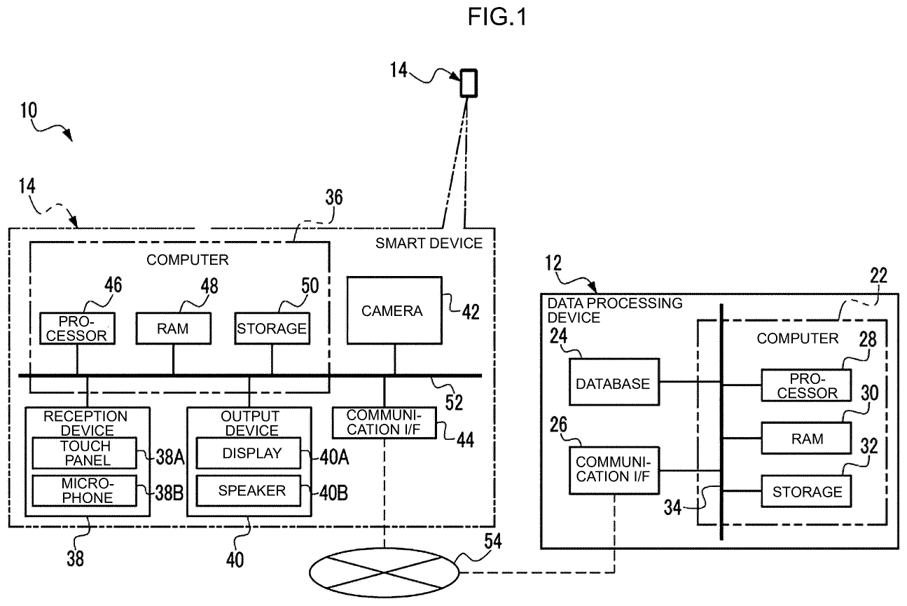

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

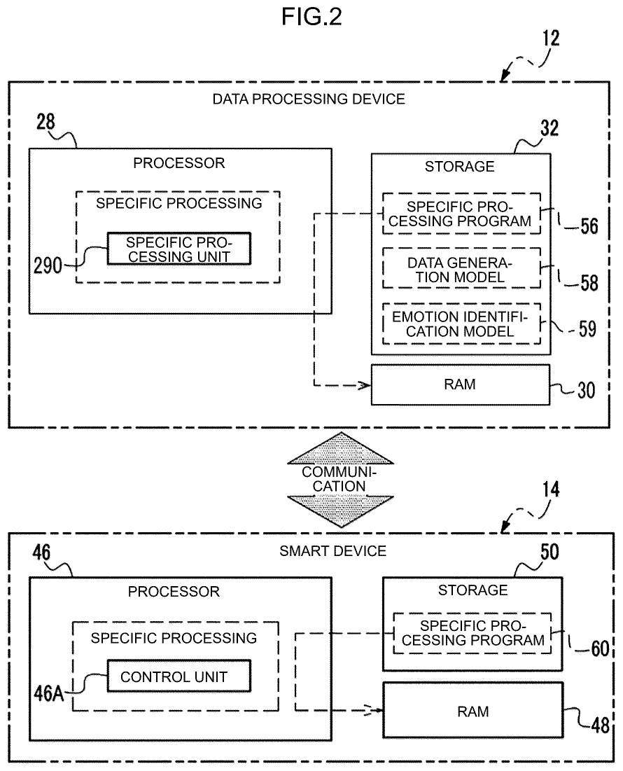

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The support system according to the embodiment of the present invention is a system that supports individuals whose work or social life has been interrupted due to fractures or injuries. This support system allows users to input their current status and goals, enables a generative AI to propose target tasks for recovery, and considers the user's post-recovery position. For example, the user inputs information such as being hospitalized due to a fracture, rehabilitation progress, and desired occupation or lifestyle after recovery. This information is input to the generative AI, which analyzes it and proposes suitable target tasks for the user. The generative AI generates optimal target tasks for the user's situation based on past data and similar cases. For instance, it may propose exercise programs tailored to rehabilitation progress or plans for acquiring skills necessary after recovery. Furthermore, the generative AI considers the user's post-recovery position. Based on the user's goals and preferences, the generative AI simulates post-recovery occupations and lifestyles and presents optimal options. For example, it may propose which occupations are suitable after recovery or what lifestyle is desirable. Through this mechanism, users can pursue recovery and restart more effectively with hope and direction. By working on the target tasks proposed by the generative AI, users can maximize the effects of rehabilitation and smoothly transition to post-recovery life. Additionally, by considering the post-recovery position, the generative AI enables users to approach rehabilitation with a future outlook and peace of mind. For example, a user hospitalized for a long period due to a fracture inputs their current status and goals to the generative AI. The generative AI proposes a rehabilitation program suited to the user's situation and presents a plan for acquiring skills necessary after recovery. Moreover, based on the user's preferences, the generative AI simulates post-recovery occupations and lifestyles and proposes optimal options. As a result, users can pursue recovery and restart more effectively with hope and direction. Thus, the support system can propose target tasks suited to the user's situation and simulate the post-recovery position. Specifically, the support system receives multidimensional data as input from the user, such as health status (e.g., fracture site, treatment progress, presence of pain), living environment (e.g., home barrier-free status, family structure, support system), and psychological state (e.g., anxiety level, motivation, stress level). The system vectorizes this information, for example, as a 128-dimensional numerical vector, and inputs it to the generative AI. Examples of input include “40-year-old male, right leg fracture, 10th day of hospitalization, 30% rehabilitation progress, hopes for desk work after recovery” and “30-year-old female, left hand fracture, recuperating at home, family support available, hopes for part-time work after recovery.” The generative AI uses Transformer-based large language models and multimodal models to match the input vector with a database of past cases (e.g., tens of thousands of rehabilitation records, return-to-work cases, lifestyle reconstruction patterns) and generates optimal target tasks for the user's situation. The output is presented as a structured list of target tasks (e.g., perform rehabilitation exercise A three times a week, acquire necessary PC skills after recovery, plan for adjusting daily routine) and achievement probability scores for each task (e.g., 80% expected achievement, 60% expected achievement). Furthermore, the system simulates post-recovery occupational aptitude and lifestyle based on the user's preferences and goals as parameters. For example, neural network-based occupational aptitude matching (input: user's skills, preferences, constraints; output: list of suitable occupations and matching scores) and lifestyle simulation (input: living environment, family structure, means of transportation; output: recommended lifestyle patterns and risk assessment) are performed. These outputs are visualized for the user in a dashboard format, and the merits and demerits of each option and future prediction graphs are also presented. In subsequent processing, the user selects and executes the proposed tasks, and the progress data is fed back to the system, enabling the AI model to continuously learn and optimize. The technical effect of the present invention is that, unlike conventional human counseling or uniform rehabilitation plans, it can automate and accelerate highly accurate task proposals and future simulations tailored to each user's situation. This enables personalized rehabilitation planning, support for social adaptation after recovery, and data-driven decision support, resulting in clear technical effects such as improved recovery rates, prevention of recurrence, and smoother social reintegration. The fields of application are diverse, including medical rehabilitation support, occupational reintegration support, support for social participation of persons with disabilities, and support for lifestyle reconstruction of long-term patients.

The support system according to the embodiment comprises a reception unit, an analysis unit, a proposal unit, and a simulation unit. The reception unit inputs the user's status. The user's status may include, for example, health status, living environment, psychological state, but is not limited thereto. For example, the reception unit allows the user to input information such as being hospitalized due to a fracture, rehabilitation progress, and desired occupation or lifestyle after recovery. The analysis unit uses a generative AI to analyze the information input by the reception unit. The analysis may be performed based on data analysis methods or algorithms used, but is not limited thereto. For example, the generative AI may use machine learning models or data generation algorithms to analyze the user's status. The proposal unit uses a generative AI to propose target tasks based on the information analyzed by the analysis unit. Target tasks may include, for example, rehabilitation goals or learning goals, but are not limited thereto. For example, the generative AI generates optimal target tasks for the user's situation based on past data and similar cases. The simulation unit uses a generative AI to simulate the post-recovery position based on the target tasks proposed by the proposal unit. The simulation may be performed based on simulation models or data used, but is not limited thereto. For example, the generative AI simulates post-recovery occupations and lifestyles based on the user's goals and preferences and presents optimal options. Thus, the support system according to the embodiment can propose target tasks suited to the user's situation and simulate the post-recovery position. Specifically, the support system receives multidimensional data from the user via the reception unit, such as health status (e.g., fracture site, treatment progress, presence of pain), living environment (e.g., home barrier-free status, family structure, support system), and psychological state (e.g., anxiety level, motivation, stress level). The reception unit converts this information into numerical vectors (e.g., 128-dimensional vectors), applies preprocessing such as standardization and normalization, and passes it to the analysis unit. Examples of input include “40-year-old male, right leg fracture, 10th day of hospitalization, 30% rehabilitation progress, hopes for desk work after recovery” and “30-year-old female, left hand fracture, recuperating at home, family support available, hopes for part-time work after recovery.” The analysis unit uses Transformer-based large language models and multimodal models to match the input vectors with a database of past cases (e.g., tens of thousands of rehabilitation records, return-to-work cases, lifestyle reconstruction patterns) and performs optimal feature extraction and clustering for the user's situation. The analysis unit may use self-attention mechanisms to extract important features and also perform anomaly detection and progress prediction. The proposal unit generates a structured list of target tasks based on the analysis results, such as rehabilitation exercise programs (e.g., perform exercise A three times a week), learning tasks (e.g., plan for acquiring PC skills), and daily routine adjustment plans, and also calculates achievement probability scores for each task (e.g., 80% expected achievement, 60% expected achievement). Furthermore, the proposal unit prioritizes and adjusts the difficulty of target tasks based on the user's physical and psychological constraints and preferences as parameters. The simulation unit takes the proposed target tasks as input and performs neural network-based occupational aptitude matching (input: user's skills, preferences, constraints; output: list of suitable occupations and matching scores) and lifestyle simulation (input: living environment, family structure, means of transportation; output: recommended lifestyle patterns and risk assessment). The simulation unit generates multiple scenarios and presents the merits and demerits of each option and future prediction graphs. In subsequent processing, the user selects and executes the proposed tasks, and the progress data is input again to the reception unit, enabling the AI model to continuously learn and optimize. The technical effect of the present invention is that, unlike conventional human counseling or uniform rehabilitation plans, it can automate and accelerate highly accurate task proposals and future simulations tailored to each user's situation. This enables personalized rehabilitation planning, support for social adaptation after recovery, and data-driven decision support, resulting in clear technical effects such as improved recovery rates, prevention of recurrence, and smoother social reintegration. The fields of application are diverse, including medical rehabilitation support, occupational reintegration support, support for social participation of persons with disabilities, and support for lifestyle reconstruction of long-term patients.

The support system comprises a monitoring unit configured to monitor the user's rehabilitation progress. The monitoring unit monitors the user's rehabilitation progress. Rehabilitation progress may include, for example, improvement in physical abilities or recovery speed, but is not limited thereto. For example, the monitoring unit measures the improvement in the user's physical abilities and evaluates the rehabilitation progress. The monitoring unit may also measure the user's recovery speed and evaluate the rehabilitation progress. Thus, by monitoring the user's rehabilitation progress, the monitoring unit enables appropriate support. Specifically, the monitoring unit acquires the user's physical parameters (e.g., walking distance, muscle strength measurement, joint range of motion, balance score) and biometric signals (e.g., heart rate, blood pressure, activity tracker data) in real time from sensor devices or wearable terminals. The monitoring unit collects these multidimensional time-series data in tensor format (e.g., two-dimensional tensor of sample count ×feature count) and applies preprocessing such as noise removal and outlier correction. Examples of input include “walking distance per day: 500 m, muscle strength measurement: 30 kg, heart rate: 80 bpm” and “joint range of motion: 90 degrees, total daily activity by activity tracker: 2000 steps.” The monitoring unit transmits these data to the analysis unit or generative AI, and progress evaluation models (e.g., time-series RNN or LSTM networks) calculate rehabilitation progress scores and recovery speed predictions. Examples of output include “rehabilitation progress: 65%, recovery speed: 10% faster than standard” and “muscle strength recovery prediction: expected to achieve target in two weeks.” The monitoring unit presents these outputs to users and medical staff via dashboards or notification functions, and issues alerts if progress is delayed. In subsequent processing, progress data is fed back to the proposal unit or simulation unit and used for automatic adjustment of target tasks or rehabilitation plans. The technical effect of the monitoring unit is that, unlike subjective human evaluation or manual record-keeping, it enables objective and high-frequency progress tracking based on sensor data, optimizing rehabilitation plans, enabling early anomaly detection, and providing individualized responses for each user. Fields of application include medical rehabilitation support, home care monitoring, sports rehabilitation, and support for persons with disabilities.

The support system comprises a generation unit in which a generative AI generates appropriate target tasks based on past data and similar cases. The generation unit uses a generative AI to generate appropriate target tasks based on past data and similar cases. The generative AI may include, for example, machine learning models or data generation algorithms, but is not limited thereto. For example, the generation unit generates optimal rehabilitation goals for the user's situation based on past rehabilitation data. The generation unit may also generate optimal learning goals for the user's situation based on similar cases. Thus, by generating target tasks based on past data and similar cases, the generation unit can propose optimal target tasks for the user. Specifically, the generation unit refers to large-scale databases of past rehabilitation records, return-to-work cases, and lifestyle reconstruction patterns, and performs similarity calculations (e.g., cosine similarity, Euclidean distance) between the user's input vector (e.g., 128-dimensional health, lifestyle, psychological state vector) and the database. The generation unit uses Transformer-based large language models and multimodal models to match the input vector with the feature space of past data. Examples of input include “40-year-old male, right leg fracture, 30% rehabilitation progress” and “30-year-old female, left hand fracture, recuperating at home.” After extracting similar cases, the generation unit generates a list of target tasks such as rehabilitation goals (e.g., achieve walking distance of 1 km, reach muscle strength of 30 kg) and learning goals (e.g., acquire PC skills, adjust daily routine), and also calculates achievement probabilities and recommended priorities for each task. Examples of output include “rehabilitation goal: exercise A three times a week, 80% expected achievement” and “learning goal: acquire PC skills, 60% expected achievement.” The generation unit links these outputs to the proposal unit and simulation unit, and automatically adjusts target tasks and scenario branching according to the user's situation and preferences. In subsequent processing, when the user selects and executes tasks, the progress data is fed back to the generation unit, enabling the AI model to continuously learn and optimize. The technical effect of the generation unit is that, unlike conventional uniform rehabilitation plans or goal setting based on human experience, it enables automatic generation and improved accuracy of individually optimized target tasks through data-driven and high-dimensional feature space similarity search. Fields of application include medical rehabilitation support, occupational reintegration support, support for social participation of persons with disabilities, and support for lifestyle reconstruction of long-term patients.

The support system comprises a database unit utilized by the generative AI when simulating post-recovery occupations and lifestyles. The database unit provides a database for the generative AI to use when simulating post-recovery occupations and lifestyles. The database may include, for example, occupation data and lifestyle data, but is not limited thereto. For example, the database unit simulates suitable occupations for the user after recovery based on occupation data. The database unit may also simulate suitable lifestyles for the user after recovery based on lifestyle data. Thus, by utilizing the database when simulating post-recovery occupations and lifestyles, the database unit improves the accuracy of simulation. Specifically, the database unit maintains a structured database of tens of thousands of occupation data (e.g., job types, required skills, work environment, return-to-work cases) and lifestyle data (e.g., lifestyle patterns, family structure, means of transportation, life satisfaction). The database unit rapidly searches and extracts relevant data in response to queries from the generative AI or simulation unit (e.g., user's skill set, desired job type, living environment conditions). Examples of input include “desired job type: desk work, skills: PC operation, constraint: unable to commute” and “living environment: barrier-free home, family support available.” The database unit provides search results to the simulation unit, which uses them as input data for neural network-based occupational aptitude matching and lifestyle simulation. Examples of output include “suitable occupation candidate: clerical work, matching score 85%” and “recommended lifestyle pattern: telework +outpatient visit once a week, risk assessment: low.” In subsequent processing, simulation results are presented to the user in dashboard format, and the user's selections and feedback are reflected in the continuous updating and optimization of the database. The technical effect of the database unit is that, unlike conventional static information provision or occupation/lifestyle proposals based on human experience, it enables rapid and highly accurate simulation using structured data and AI, allowing individual optimization and improved reliability of future predictions for each user. Fields of application include medical rehabilitation support, occupational reintegration support, support for social participation of persons with disabilities, and support for lifestyle reconstruction of long-term patients.

The proposal unit is configured to propose an exercise program according to the progress of rehabilitation. The proposal unit uses a generative AI to propose an exercise program according to the progress of rehabilitation. The exercise program may include, for example, type, intensity, and frequency of exercise, but is not limited thereto. For example, the proposal unit proposes an appropriate exercise program based on the user's rehabilitation progress. The proposal unit may also adjust the intensity and frequency of the exercise program according to the user's physical abilities. Thus, by proposing an exercise program according to the progress of rehabilitation, the proposal unit can maximize the user's rehabilitation effect. Specifically, the proposal unit receives user physical ability data (e.g., muscle strength measurement, walking distance, joint range of motion, activity level) and rehabilitation progress scores obtained from the monitoring unit or analysis unit. The proposal unit converts these data into vectors such as 128-dimensional vectors and inputs them to the generative AI (e.g., Transformer-based large language model or time-series RNN). Examples of input include “muscle strength: 30 kg, walking distance: 500 m, progress: 65%” and “joint range of motion: 90 degrees, activity: 2000 steps.” The proposal unit matches these data with past rehabilitation databases and similar cases and generates exercise programs (e.g., exercise A three times a week, exercise B twice a week, intensity level 2, frequency: every other day). Examples of output include “recommended exercise: 10 squats×3 sets, three times a week, intensity level 2” and “stretching exercise, daily, intensity level 1.” Furthermore, the proposal unit automatically adjusts the difficulty and frequency of the program by considering the user's physical constraints and psychological state (e.g., fatigue level, motivation). In subsequent processing, the proposed exercise program is presented to the user or medical staff, and the results and feedback are input again to the system, enabling the AI model to continuously learn and optimize. The technical effect of the proposal unit is that, unlike conventional uniform exercise programs or proposals based on human experience, it enables individual optimization and automatic adjustment based on sensor data and progress, maximizing rehabilitation effects, enabling early recovery, and preventing recurrence. Fields of application include medical rehabilitation support, home care support, sports rehabilitation, and support for persons with disabilities.

The simulation unit is configured to simulate post-recovery occupations and lifestyles based on the user's preferences. The simulation unit uses a generative AI to simulate post-recovery occupations and lifestyles based on the user's preferences. The user's preferences may include, for example, types of occupation and choices of lifestyle, but are not limited thereto. For example, the simulation unit simulates suitable occupations after recovery based on the user's preferences. The simulation unit may also simulate suitable lifestyles after recovery based on the user's preferences. Thus, by simulating post-recovery occupations and lifestyles based on the user's preferences, the simulation unit can provide optimal options for the user. Specifically, the simulation unit vectorizes the user's input preference information (e.g., desired job type, work style, daily routine, family structure, means of transportation, hobbies and preferences) as numerical vectors of 128 dimensions or more and inputs them to the generative AI. The simulation unit uses Transformer-based large language models and multimodal neural networks to match the input vectors with occupation and lifestyle databases (e.g., tens of thousands of occupation cases, lifestyle patterns, post-recovery satisfaction data). Examples of input include “desired job type: telework, lifestyle: morning type, family structure: spouse +one child” and “desired job type: light work, lifestyle: three days a week, means of transportation: public transport.” The simulation unit calculates similarity (e.g., cosine similarity, Euclidean distance) between the input vector and each case in the database and extracts the most suitable occupation and lifestyle candidates. Furthermore, the simulation unit performs future prediction using neural networks (e.g., post-recovery satisfaction score, lifestyle risk assessment, health maintenance prediction) for the extracted candidates and scores each option. Examples of output include “suitable occupation candidate: clerical work (matching score 85%, satisfaction prediction 80 points)” and “recommended lifestyle pattern: telework +outpatient visit once a week (risk assessment: low).” These outputs are presented to the user in dashboard format, and the merits and demerits of each option and future prediction graphs are visualized. In subsequent processing, the user selects options, and the selection and feedback are fed back to the simulation unit and database unit, enabling the AI model to continuously learn and optimize. The technical effect of the simulation unit is that, unlike conventional support based on human experience or uniform return-to-work support, it can automatically and rapidly generate individually optimized future scenarios by matching multidimensional user preference data with large-scale case databases in high-dimensional space. This enables personalized support for social adaptation after recovery, lifestyle reconstruction, and advanced decision support, resulting in clear technical effects such as improved user satisfaction, prevention of recurrence, and smoother social reintegration. Fields of application include medical rehabilitation support, occupational reintegration support, support for social participation of persons with disabilities, support for lifestyle reconstruction of long-term patients, as well as support for life planning for the elderly and career change/reemployment support.

The reception unit is configured to estimate the user's emotions and adjust the display method of the input interface based on the estimated emotions. The reception unit uses a generative AI to estimate the user's emotions and adjust the display method of the input interface based on the estimated emotions. The user's emotions may include, for example, anxiety, relaxation, impatience, but are not limited thereto. For example, if the user feels anxious, the reception unit provides an interface with calm colors to give a sense of security. If the user is relaxed, the reception unit provides an interface with bright colors to make input tasks enjoyable. If the user is impatient, the reception unit provides a simple and highly visible interface to enable quick input. Thus, by adjusting the display method of the input interface according to the user's emotions, the reception unit makes the user's input tasks comfortable. Emotion estimation is realized using emotion estimation functions such as emotion engines or generative AI. The generative AI may be a text generative AI (e.g., LLM) or a multimodal generative AI, but is not limited thereto. Specifically, the reception unit receives various input data such as text data entered by the user (e.g., natural language sentences like “Rehabilitation has been tough lately” or “I'm feeling good today”), voice data (e.g., speech speed and tone), and facial images (e.g., face images captured by a camera). The reception unit preprocesses these data, tokenizes and embeds text (e.g., 512-dimensional vectors), converts voice to spectrograms and extracts features (e.g., MFCC features), and extracts facial feature points from images (e.g., 68-point landmarks). Examples of input include “utterance text: ‘I'm anxious today’”, “voice data with a subdued tone”, and “smiling face image.” The reception unit inputs these multimodal feature vectors to a multimodal Transformer or large language model with self-attention mechanisms, and outputs emotion classification (e.g., labels such as anxiety, relaxation, impatience, joy, anger) and emotion scores (e.g., anxiety level 0.8, relaxation level 0.2 as probability distributions). Examples of output include “emotion label: anxiety, score 0.75” and “emotion label: relaxation, score 0.60.” Based on these output results, the reception unit automatically adjusts the interface's color scheme (e.g., calm blue tones, bright yellow tones), layout (e.g., simple button arrangement, detailed explanation display), and input assistance (e.g., presence of input guides, number of input items). In subsequent processing, the reception unit continuously collects reaction data when the user operates the interface (e.g., input speed, number of input errors, re-entry requests) and uses it to optimize AI model parameters and improve the interface. The technical effect of the reception unit is that, unlike conventional static interface design or subjective human judgment, it realizes multidimensional emotion estimation and real-time interface optimization by AI, thereby reducing psychological burden, improving input efficiency, reducing input errors, and enhancing user satisfaction. Fields of application include medical rehabilitation support systems, input support for persons with disabilities, stress care applications, educational interfaces, and customer support systems.

The reception unit is configured to analyze the user's past input history and propose an appropriate input method. The reception unit uses a generative AI to analyze the user's past input history and propose an appropriate input method. Past input history may include, for example, methods of saving input data and analysis techniques, but is not limited thereto. For example, the reception unit automatically displays information that the user has frequently input in the past as candidates. The reception unit may also preferentially propose input methods (such as voice or text) that the user has used in the past. Furthermore, the reception unit may predict and propose information used at specific times based on the user's past input history. Thus, by analyzing the user's past input history, the reception unit can propose the optimal input method. Specifically, the reception unit acquires input history data recorded in time series for each user (e.g., structured log data including input date and time, input content, input method, input time required, number of input errors) from the database. The reception unit vectorizes these history data as time-series vectors (e.g., each history as a 128-dimensional vector, with the most recent 30 entries arrayed) and inputs them to the generative AI. Examples of input include “2024-06-01 10:00 text input ‘right leg pain’”, “2024-06-02 09:30 voice input ‘rehabilitation progress 30%’”, and “2024-06-03 20:00 text input ‘feeling good’.” The reception unit uses Transformer-based time-series analysis models or LSTM networks to extract patterns and perform clustering of input history, automatically learning the user's preferred input methods (e.g., frequent use of voice input, more text input at night) and input tendencies (e.g., repeated input of specific items, changes in input content by day of the week). Examples of output include “recommended input method: voice input (recommendation score 0.85)”, “candidate input items: ‘rehabilitation progress’, ‘presence of pain’”, and “recommended input time: after 8 p.m.” Based on these output results, the reception unit realizes automatic completion of input candidates, default switching of input methods, and prioritized display of input items according to time of day on the input interface. In subsequent processing, the input methods and results actually selected and used by the user are accumulated as feedback data and used for continuous learning and optimization of the AI model. The technical effect of the reception unit is that, unlike conventional static input forms or input support based on human experience, it automates and accelerates input proposal by AI through history pattern analysis and individual optimization, thereby improving input efficiency, reducing input errors, reducing user burden, and increasing system usage rate. Fields of application include medical rehabilitation support systems, input assistance for persons with disabilities, business daily report systems, educational learning record systems, and customer support reception.

The reception unit is configured to customize input items at the time of input based on the user's current physical condition and psychological state. The reception unit uses a generative AI to customize input items at the time of input based on the user's current physical condition and psychological state. Physical condition may include, for example, health status or physical abilities, but is not limited thereto. For example, if the user is tired, the reception unit minimizes and simplifies input items. If the user is relaxed, the reception unit provides detailed input items and may propose customizable input methods. If the user is stressed, the reception unit prioritizes voice input to enable quick input. Thus, by customizing input items based on the user's current physical condition and psychological state, the reception unit can reduce the user's burden. Specifically, the reception unit acquires multidimensional numerical vectors (e.g., 128 dimensions) in real time, such as health status data entered by the user (e.g., walking distance, muscle strength measurement, fatigue score, presence of pain) and psychological state data (e.g., stress level, motivation, mood score). The reception unit inputs these data to a generative AI (e.g., multimodal large language model) and classifies the user's state (e.g., fatigue, relaxation, stress) or scores it (e.g., fatigue level 0.7, stress level 0.8). Examples of input include “muscle strength: 25 kg, fatigue level: 0.8, stress level: 0.6” and “mood: relaxed, pain: none.” Based on the AI output, the reception unit automatically adjusts the number and content of input items. For example, if fatigue level is high, only minimal items such as “today's rehabilitation progress” or “presence of pain” are displayed; if in a relaxed state, multiple items such as “detailed rehabilitation content,” “changes in living environment,” and “detailed psychological state” are presented. If stress level is high, voice input or selection-type input is prioritized to reduce input burden. Examples of output include “number of displayed items: 2, input method: voice prioritized” and “number of displayed items: 8, input method: text+selection.” In subsequent processing, the reception unit continuously monitors input completion rate, input time required, and input error rate, and uses them to optimize AI model parameters and improve input item design. The technical effect of the reception unit is that, unlike conventional uniform input forms or subjective human judgment, it realizes multidimensional state estimation and real-time input item optimization by AI, thereby greatly reducing user burden, improving input efficiency and accuracy, and enhancing user satisfaction. Fields of application include medical rehabilitation support systems, input support for persons with disabilities, stress care applications, educational interfaces, and business daily report systems.

The reception unit is configured to estimate the user's emotions and determine the priority of input based on the estimated emotions. The reception unit uses a generative AI to estimate the user's emotions and determine the priority of input based on the estimated emotions. The user's emotions may include, for example, impatience, relaxation, anxiety, but are not limited thereto. For example, if the user is impatient, the reception unit preferentially displays important input items. If the user is relaxed, the reception unit provides detailed input items and may propose customizable input methods. If the user feels anxious, the reception unit preferentially displays input items that provide a sense of security. Thus, by determining the priority of input according to the user's emotions, the reception unit can preferentially display important input items. Emotion estimation is realized using emotion estimation functions such as emotion engines or generative AI. The generative AI may be a text generative AI (e.g., LLM) or a multimodal generative AI, but is not limited thereto. Specifically, the reception unit receives multimodal data such as natural language text entered by the user (e.g., “I'm in a hurry today”, “I feel anxious”), voice data (e.g., speech speed and tone), and facial images (e.g., face images captured by a camera). The reception unit preprocesses these data, tokenizes and vectorizes text, extracts features from voice, and extracts facial feature points from images, and inputs them to a multimodal AI model (e.g., Transformer-based). The AI model outputs emotion classification (e.g., impatience, relaxation, anxiety) and emotion scores (e.g., impatience level 0.8, anxiety level 0.6). Examples of output include “emotion: impatience, score 0.85” and “emotion: relaxation, score 0.70.” Based on these outputs, the reception unit automatically determines the priority of input items. For example, if impatience level is high, “high-priority input items (e.g., presence of pain, rehabilitation progress)” are displayed at the top; if relaxation level is high, “detailed input items (e.g., living environment, psychological state)” are additionally displayed; if anxiety level is high, “input items that provide a sense of security (e.g., support system, consultation window)” are preferentially displayed. In subsequent processing, the reception unit continuously monitors the user's input selection, input completion rate, and input time required, and uses them to optimize AI model parameters and improve input item design. The technical effect of the reception unit is that, unlike conventional static input forms or priority setting based on human experience, it realizes multidimensional emotion estimation and real-time input item prioritization by AI, thereby improving input efficiency, reducing user burden, enabling rapid acquisition of important information, and enhancing user satisfaction. Fields of application include medical rehabilitation support systems, input support for persons with disabilities, stress care applications, educational interfaces, and customer support reception.

The reception unit is configured to preferentially display highly relevant input items at the time of input by considering the user's geographic location information. The reception unit uses a generative AI to preferentially display highly relevant input items at the time of input by considering the user's geographic location information. Geographic location information may include, for example, GPS data or location information services, but is not limited thereto. For example, if the user is in a hospital, the reception unit preferentially displays medical-related input items. If the user is at home, the reception unit preferentially displays rehabilitation-related input items. If the user is outside, the reception unit preferentially displays input items related to movement. Thus, by considering the user's geographic location information and preferentially displaying highly relevant input items, the reception unit improves input efficiency. Specifically, the reception unit acquires GPS coordinate data (e.g., latitude 35.6895, longitude 139.6917, accuracy 5 m) obtained from user devices (e.g., smartphones, tablets, wearable devices), Wi-Fi/Bluetooth-based location information, and facility name/address information from location information service APIs as multidimensional vectors (e.g., 64-dimensional vectors including location coordinates, facility category, and time information) in real time. The reception unit inputs these geographic location vectors to a generative AI (e.g., multimodal Transformer model) and matches them with past usage history databases and facility attribute databases (e.g., labeled data for hospitals, rehabilitation facilities, homes, public transportation, commercial facilities). Examples of input include “location: in hospital, time: 10 a.m.”, “location: at home, time: 8 p.m.”, and “location: in station, time: 3 p.m.” The generative AI calculates similarity (e.g., cosine similarity, distance-based score) between the input location vector and the facility attribute database and automatically determines the most relevant scenario. Examples of output include “priority input items: consultation details, medication status, next outpatient visit (when in hospital)”, “priority input items: rehabilitation progress, daily activities, family support status (when at home)”, and “priority input items: means of transportation, travel distance, purpose of outing (when outside)” as structured lists. Furthermore, the reception unit also considers the user's past input tendencies and time information, and automatically adjusts the order and display format of input items (e.g., buttons, selection type, voice input recommendation). In subsequent processing, the reception unit accumulates feedback data such as actual input content, input completion rate, and input time required, and uses it for continuous learning and optimization of the AI model. The technical effect of the reception unit is that, unlike conventional static input forms or item presentation based on human experience, it realizes real-time geographic location estimation and multidimensional data analysis by AI, enabling automatic presentation of input items optimized for the user's current location and usage scenario. This results in improved input efficiency, reduced input errors, reduced user burden, and increased system usage rate. Fields of application include medical rehabilitation support systems, home care support, outing support applications, input assistance for persons with disabilities, business daily report systems, and mobile healthcare applications.

The reception unit is configured to analyze the user's social media activity at the time of input and propose relevant input items. The reception unit uses a generative AI to analyze the user's social media activity at the time of input and propose relevant input items. Social media activity may include, for example, post content and activity frequency, but is not limited thereto. For example, if the user posts about rehabilitation on social media, the reception unit proposes rehabilitation-related input items. If the user posts about occupation on social media, the reception unit may propose occupation-related input items. If the user posts about health on social media, the reception unit may propose health-related input items. Thus, by analyzing the user's social media activity, the reception unit can propose relevant input items. Specifically, the reception unit collects post data obtained from social media APIs within the scope permitted by the user (e.g., text posts, images, videos, post time, number of likes, number of comments) in time series, and uses a natural language processing engine to tokenize and vectorize post content (e.g., each post as a 512-dimensional vector). Furthermore, to classify post frequency and post categories (e.g., rehabilitation, occupation, health, hobbies, family, travel), the reception unit uses Transformer-based large language models and multimodal models to perform semantic analysis and sentiment analysis (e.g., positive, negative, neutral) of post content. Examples of input include “2024-06-01 ‘I'm working hard on rehabilitation’”, “2024-06-02 ‘Trying a new job’”, and “2024-06-03 ‘Feeling well lately’.” Based on these analysis results, the reception unit estimates the user's areas of interest and current living situation, and preferentially displays highly relevant input items (e.g., rehabilitation progress, occupation preferences, health status, changes in living environment) on the input interface. Examples of output include “recommended input items: rehabilitation progress, exercise content”, “recommended input items: occupation preferences, work style”, and “recommended input items: health status, medication status.” Furthermore, the reception unit also considers post frequency and time patterns (e.g., frequent health posts at night) and automatically adjusts the timing of input item display and input assistance functions (e.g., auto-completion, input candidate suggestion). In subsequent processing, the reception unit accumulates feedback data such as actual input content, input completion rate, input time required, and input error rate, and uses it for continuous learning and optimization of the AI model. The technical effect of the reception unit is that, unlike conventional static input forms or input support based on human experience, it automates and accelerates input item proposal by AI through social media activity analysis and individual optimization, thereby improving input efficiency, reducing input errors, reducing user burden, and increasing system usage rate. Fields of application include medical rehabilitation support systems, input assistance for persons with disabilities, business daily report systems, educational learning record systems, customer support reception, and personal healthcare applications.

The analysis unit is configured to estimate the user's emotions and adjust the analysis algorithm based on the estimated emotions. The analysis unit uses a generative AI to estimate the user's emotions and adjust the analysis algorithm based on the estimated emotions. The user's emotions may include, for example, relaxation, impatience, anxiety, but are not limited thereto. For example, if the user is relaxed, the analysis unit performs detailed analysis to improve accuracy. If the user is impatient, the analysis unit performs rapid analysis to provide results quickly. If the user feels anxious, the analysis unit may provide analysis results that give a sense of security. Thus, by adjusting the analysis algorithm according to the user's emotions, the analysis unit improves the accuracy of analysis results. Emotion estimation is realized using emotion estimation functions such as emotion engines or generative AI. The generative AI may be a text generative AI (e.g., LLM) or a multimodal generative AI, but is not limited thereto. Specifically, the analysis unit receives multimodal data such as natural language text entered by the user (e.g., “I'm feeling good today”, “I feel anxious”), voice data (e.g., speech speed and tone), and facial images (e.g., face images captured by a camera). The analysis unit preprocesses these data, tokenizes and vectorizes text (e.g., 512-dimensional vectors), extracts MFCC features from voice, and extracts facial feature points from images (e.g., 68-point landmarks). Examples of input include “utterance text: ‘I'm relaxed today’”, “voice data with a high tone”, and “smiling face image.” The analysis unit inputs these multimodal feature vectors to a multimodal Transformer or large language model with self-attention mechanisms, and outputs emotion classification (e.g., labels such as relaxation, impatience, anxiety) and emotion scores (e.g., relaxation level 0.7, impatience level 0.2, anxiety level 0.1 as probability distributions). Examples of output include “emotion label: relaxation, score 0.75” and “emotion label: impatience, score 0.60.” Based on these output results, the analysis unit automatically adjusts analysis algorithm parameters (e.g., analysis depth, number of selected features, processing batch size, threshold settings). For example, if relaxation level is high, detailed feature extraction and multi-stage clustering are performed to maximize analysis accuracy. If impatience level is high, features are narrowed down and the number of inferences is reduced to prioritize speed. If anxiety level is high, the analysis unit emphasizes interpretability and reassurance in the analysis results, highlighting interpretable features and comparisons with past successful cases. In subsequent processing, analysis results are linked to the proposal unit and simulation unit and used for automatic adjustment of target tasks and future scenarios according to the user's emotional state. The technical effect of the analysis unit is that, unlike conventional uniform analysis flows or subjective human judgment, it realizes multidimensional emotion estimation and real-time analysis algorithm optimization by AI, thereby improving analysis accuracy, optimizing processing speed, reducing psychological burden, and enhancing interpretability. Fields of application include medical rehabilitation support systems, analysis support for persons with disabilities, stress care applications, educational analysis systems, and customer support analysis.

The analysis unit is configured to refer to the user's past data during analysis to improve the accuracy of analysis. The analysis unit uses a generative AI to refer to the user's past data during analysis to improve the accuracy of analysis. Past data may include, for example, history data or log data, but is not limited thereto. For example, the analysis unit refers to the user's past rehabilitation data to perform optimal analysis for the current situation. The analysis unit may also refer to the user's past health data to improve the accuracy of analysis. The analysis unit may also refer to the user's past occupation data to analyze post-recovery occupations. Thus, by referring to the user's past data, the analysis unit improves the accuracy of analysis. Specifically, the analysis unit refers to structured databases of rehabilitation history data recorded in time series for each user (e.g., rehabilitation dates, exercise content, progress, achievement rate), health data (e.g., body temperature, blood pressure, heart rate, muscle strength measurement), and occupation data (e.g., past job types, work content, work style, return-to-work history). The analysis unit vectorizes these history data as time-series vectors (e.g., each history as a 128-dimensional vector, with the most recent 30 entries arrayed) and inputs them to the generative AI. Examples of input include “2024-06-01 rehabilitation progress 60%”, “2024-06-02 muscle strength measurement 28 kg”, and “2024-06-03 occupation: clerical work.” The analysis unit uses Transformer-based time-series analysis models or LSTM networks to extract patterns and perform clustering of history data, automatically learning the user's recovery trends, changes in health status, and transitions in occupational aptitude. AI output includes selection of optimal analysis methods for the current situation (e.g., parameter optimization of progress prediction models, automatic adjustment of anomaly detection thresholds), comparison graphs with past data, and future prediction values (e.g., predicted muscle strength recovery in two weeks). Examples of output include “progress prediction: 80% expected achievement”, “health status: stable”, and “occupational aptitude: desk work matching score 85%.” In subsequent processing, analysis results are linked to the proposal unit and simulation unit and used for generation of individually optimized target tasks and future scenarios based on the user's past data. The technical effect of the analysis unit is that, unlike conventional static analysis or judgment based on human experience, it realizes history pattern analysis and automatic selection of individually optimized analysis methods by AI, thereby improving analysis accuracy, enabling early anomaly detection, providing individualized responses for each user, and enhancing decision support. Fields of application include medical rehabilitation support systems, analysis support for persons with disabilities, business daily report analysis, educational learning record analysis, and customer support history analysis.

The analysis unit is configured to customize the analysis method during analysis based on the user's current physical condition. The analysis unit uses a generative AI to customize the analysis method during analysis based on the user's current physical condition. Physical condition may include, for example, health status or physical abilities, but is not limited thereto. For example, if the user is tired, the analysis unit uses a simplified analysis method. If the user is relaxed, the analysis unit may use a detailed analysis method. If the user is stressed, the analysis unit may use a rapid analysis method. Thus, by customizing the analysis method based on the user's current physical condition, the analysis unit can provide optimal analysis results for the user. Specifically, the analysis unit acquires multidimensional numerical vectors (e.g., 128 dimensions) in real time, such as health status data entered by the user (e.g., walking distance, muscle strength measurement, fatigue score, presence of pain), physical ability data (e.g., joint range of motion, activity level, balance score), and psychological state data (e.g., stress level, motivation, mood score). The analysis unit inputs these data to a generative AI (e.g., multimodal large language model) and classifies the user's state (e.g., fatigue, relaxation, stress) or scores it (e.g., fatigue level 0.7, stress level 0.8). Examples of input include “muscle strength: 25 kg, fatigue level: 0.8, stress level: 0.6” and “mood: relaxed, pain: none.” Based on the AI output, the analysis unit automatically adjusts the selection of analysis methods and parameters (e.g., number of selected features, analysis depth, batch size, threshold settings). For example, if fatigue level is high, only major features are extracted and simple clustering or progress prediction models are applied to reduce computational load. If in a relaxed state, multi-stage analysis, detailed anomaly detection, and ensemble analysis of multiple models are performed to maximize accuracy. If stress level is high, models with high real-time performance are selected to prioritize processing speed. Examples of output include “analysis method: simple clustering, 5 major features” and “analysis method: detailed multi-stage analysis, 20 features.” In subsequent processing, analysis results are linked to the proposal unit and simulation unit and used for automatic adjustment of target tasks and future scenarios according to the user's physical condition. The technical effect of the analysis unit is that, unlike conventional uniform analysis flows or subjective human judgment, it realizes multidimensional state estimation and real-time optimization of analysis methods by AI, thereby greatly reducing user burden, improving analysis efficiency and accuracy, and enhancing user satisfaction. Fields of application include medical rehabilitation support systems, analysis support for persons with disabilities, stress care applications, educational analysis systems, and business daily report analysis.

The analysis unit is configured to estimate the user's emotions and adjust the display method of the analysis results based on the estimated emotions. The analysis unit uses a generative AI to estimate the user's emotions and adjust the display method of the analysis results based on the estimated emotions. The user's emotions may include, for example, tension, relaxation, urgency, but are not limited thereto. For example, if the user is tense, the analysis unit provides a simple and highly visible display method. If the user is relaxed, the analysis unit may provide a display method that includes detailed information. If the user is in a hurry, the analysis unit may provide a display method that focuses on key points. Thus, by adjusting the display method of the analysis results according to the user's emotions, the analysis unit enables easy-to-read displays for the user. Emotion estimation is realized using emotion estimation functions such as emotion engines or generative AI. The generative AI may be a text generative AI (e.g., LLM) or a multimodal generative AI, but is not limited thereto. Specifically, the analysis unit receives multimodal data such as natural language text entered by the user (e.g., “I'm in a hurry today”, “I'm tense”), voice data (e.g., speech speed and tone), and facial images (e.g., face images captured by a camera). The analysis unit preprocesses these data, tokenizes and vectorizes text, extracts features from voice, and extracts facial feature points from images, and inputs them to a multimodal AI model (e.g., Transformer-based). The AI model outputs emotion classification (e.g., tension, relaxation, urgency) and emotion scores (e.g., tension level 0.8, relaxation level 0.6, urgency level 0.7). Examples of output include “emotion: tension, score 0.85” and “emotion: relaxation, score 0.70.” Based on these outputs, the analysis unit automatically adjusts the display method of the analysis results (e.g., color scheme, layout, amount of information, presence of graphs). For example, if tension level is high, a simple color scheme, large font, and emphasis on key points are used; if relaxation level is high, detailed graphs, supplementary explanations, and comparison information with past data are additionally displayed; if urgency level is high, only the most important items are displayed at the top, and detailed information is shown in a collapsible format. In subsequent processing, the analysis unit accumulates feedback data such as user's display selection, viewing time, and re-display requests, and uses it for continuous learning and optimization of the AI model. The technical effect of the analysis unit is that, unlike conventional static display design or subjective human judgment, it realizes multidimensional emotion estimation and real-time display optimization by AI, thereby reducing psychological burden, improving information comprehension, preventing misunderstandings, and enhancing user satisfaction. Fields of application include medical rehabilitation support systems, analysis support for persons with disabilities, stress care applications, educational analysis systems, and customer support analysis.

The analysis unit is configured to improve the accuracy of analysis by considering the user's geographic location information during analysis. The analysis unit uses a generative AI to improve the accuracy of analysis by considering the user's geographic location information during analysis. Geographic location information may include, for example, GPS data or location information services, but is not limited thereto. For example, if the user is in a hospital, the analysis unit prioritizes analysis of medical-related data. If the user is at home, the analysis unit may prioritize analysis of rehabilitation-related data. If the user is outside, the analysis unit may prioritize analysis of movement-related data. Thus, by considering the user's geographic location information, the analysis unit improves the accuracy of analysis. Specifically, the analysis unit acquires GPS coordinate data (e.g., latitude 35.6895, longitude 139.6917, accuracy 5 m) obtained from user devices (e.g., smartphones, tablets, wearable devices), Wi-Fi/Bluetooth-based location information, and facility name/address information from location information service APIs as multidimensional vectors (e.g., 64-dimensional vectors including location coordinates, facility category, and time information) in real time. The analysis unit inputs these geographic location vectors to a generative AI (e.g., multimodal Transformer model) and matches them with past usage history databases and facility attribute databases (e.g., labeled data for hospitals, rehabilitation facilities, homes, public transportation, commercial facilities). Examples of input include “location: in hospital, time: 10 a.m.”, “location: at home, time: 8 p.m.”, and “location: in station, time: 3 p.m.” The generative AI calculates similarity (e.g., cosine similarity, distance-based score) between the input location vector and the facility attribute database and automatically determines the most relevant scenario. Based on the determination result, the analysis unit automatically switches the priority of analysis target data and analysis methods (e.g., medical data priority analysis, rehabilitation data priority analysis, movement data priority analysis). Examples of output include “analysis target: medical data, priority 90%” and “analysis target: rehabilitation data, priority 80%.” In subsequent processing, analysis results are linked to the proposal unit and simulation unit and used for automatic adjustment of target tasks and future scenarios according to the user's geographic location. The technical effect of the analysis unit is that, unlike conventional static analysis flows or judgment based on human experience, it realizes real-time geographic location estimation and multidimensional data analysis by AI, enabling automation and improved accuracy of analysis optimized for the user's current location and usage scenario. This results in improved analysis efficiency, reduced analysis errors, reduced user burden, and increased system usage rate. Fields of application include medical rehabilitation support systems, home care support, outing support applications, analysis assistance for persons with disabilities, business daily report analysis, and mobile healthcare analysis.

The analysis unit is configured to analyze the user's social media activity during analysis and utilize relevant data in the analysis. The analysis unit uses a generative AI to analyze the user's social media activity during analysis and utilize relevant data in the analysis. Social media activity may include, for example, post content and activity frequency, but is not limited thereto. For example, if the user posts about rehabilitation on social media, the analysis unit utilizes rehabilitation-related data in the analysis. If the user posts about occupation on social media, the analysis unit may utilize occupation-related data in the analysis. If the user posts about health on social media, the analysis unit may utilize health-related data in the analysis. Thus, by analyzing the user's social media activity, the analysis unit can utilize relevant data in the analysis. Specifically, the analysis unit collects post data obtained from social media APIs within the scope permitted by the user (e.g., text posts, images, videos, post time, number of likes, number of comments) in time series, and uses a natural language processing engine to tokenize and vectorize post content (e.g., each post as a 512-dimensional vector). Furthermore, to classify post frequency and post categories (e.g., rehabilitation, occupation, health, hobbies, family, travel), the analysis unit uses Transformer-based large language models and multimodal models to perform semantic analysis and sentiment analysis (e.g., positive, negative, neutral) of post content. Examples of input include “2024-06-01 ‘I'm working hard on rehabilitation’”, “2024-06-02 ‘Trying a new job’”, and “2024-06-03 ‘Feeling well lately’.” Based on these analysis results, the analysis unit estimates the user's areas of interest and current living situation, and preferentially extracts highly relevant data (e.g., rehabilitation progress, occupation preferences, health status, changes in living environment) as analysis targets. AI output includes “analysis target: rehabilitation data, priority 90%”, “analysis target: occupation data, priority 80%”, and “analysis target: health data, priority 85%.” Furthermore, the analysis unit also considers post frequency and time patterns (e.g., frequent health posts at night) and automatically adjusts analysis timing and methods (e.g., time-series analysis, clustering, sentiment trend analysis). In subsequent processing, analysis results are linked to the proposal unit and simulation unit and used for generation of individually optimized target tasks and future scenarios based on the user's social media activity. The technical effect of the analysis unit is that, unlike conventional static analysis flows or analysis based on human experience, it automates and accelerates extraction of individually optimized analysis targets by AI through social media activity analysis, thereby improving analysis efficiency, reducing analysis errors, reducing user burden, and increasing system usage rate. Fields of application include medical rehabilitation support systems, analysis assistance for persons with disabilities, business daily report analysis, educational learning record analysis, customer support analysis, and personal healthcare analysis.

The proposal unit can estimate the user's emotions and adjust the expression method of proposals based on the estimated emotions. The proposal unit uses generative AI to estimate the user's emotions and adjusts the expression method of proposals based on the estimated emotions. The user's emotions may include, for example, relaxation, impatience, anxiety, and the like, but are not limited thereto. For example, when the user is relaxed, the proposal unit provides detailed proposals and offers many options. When the user is impatient, the proposal unit can provide concise proposals and quickly present options. When the user feels anxious, the proposal unit can provide proposals that give a sense of security and reduce the number of options. Thus, by adjusting the expression method of proposals according to the user's emotions, the proposal unit can provide proposals that are easy for the user to understand. Emotion estimation is realized, for example, by using an emotion estimation function with an emotion engine or generative AI. The generative AI may be a text generative AI (e.g., LLM) or a multimodal generative AI, but is not limited thereto. Specifically, the proposal unit receives multimodal data such as natural language text input by the user (e.g., “I am calm today”, “I am in a hurry”, “I feel anxious”), voice data (e.g., speech speed and tone), and facial images (e.g., face images captured by a camera). The proposal unit preprocesses these data: text is tokenized and vectorized (e.g., 512-dimensional vector), voice features are extracted using MFCC, and facial features are extracted from images (e.g., 68-point landmarks). Examples of input include “Speech text: ‘I am relaxed today’”, “Voice data with high tone”, “Smiling face image”, and so on. The proposal unit inputs these multimodal feature vectors into a multimodal Transformer or a large language model with self-attention mechanism, and outputs emotion classification (e.g., labels such as relaxation, impatience, anxiety) and emotion scores (e.g., relaxation score 0.7, impatience score 0.2, anxiety score 0.1 as probability distribution). Examples of output include “Emotion label: relaxation, score 0.75”, “Emotion label: impatience, score 0.60”, and so on. Based on these output results, the proposal unit automatically adjusts the expression method of proposals (e.g., level of detail, number of options, length of explanation, color scheme, layout). For example, when the relaxation score is high, detailed explanations and multiple options (e.g., rehabilitation exercises A to C, lifestyle improvement plans 1 to 3) are presented so that the user can carefully compare and consider. When the impatience score is high, concise proposals summarizing only the main points (e.g., only one most important issue, two options) are displayed with large buttons to support quick decision-making. When the anxiety score is high, proposals are made with a color scheme that gives a sense of security (e.g., blue tones), emphasis on support systems and past success stories, and a reduced number of options (e.g., one or two). As a subsequent process, reaction data when the user selects or executes a proposal (e.g., selection speed, re-proposal requests, satisfaction feedback) are continuously collected and used to optimize AI model parameters and improve proposal expression. As a technical effect, the proposal unit, unlike conventional static proposal displays or subjective human judgment, realizes multidimensional emotion estimation by AI and real-time optimization of proposal expression, thereby providing clear technical effects such as reduction of psychological burden on the user, improvement of decision-making efficiency, prevention of misunderstandings, and enhancement of user satisfaction. Application fields include medical rehabilitation support systems, decision support for persons with disabilities, stress care applications, educational proposal systems, customer support proposals, and many others.

The proposal unit can refer to the user's past data at the time of proposal to improve the accuracy of proposals. The proposal unit uses generative AI to refer to the user's past data at the time of proposal to improve the accuracy of proposals. Past data may include, for example, history data and log data, but are not limited thereto. For example, the proposal unit refers to the user's past rehabilitation data to make optimal proposals for the current situation. The proposal unit can also refer to the user's past health data to improve the accuracy of proposals. Furthermore, the proposal unit can refer to the user's past occupational data to make proposals regarding post-recovery occupations. Thus, by referring to the user's past data, the proposal unit improves the accuracy of proposals. Specifically, the proposal unit refers to structured databases such as rehabilitation history data recorded chronologically for each user (e.g., rehabilitation dates, exercise details, progress rate, achievement rate), health data (e.g., body temperature, blood pressure, heart rate, muscle strength measurements), and occupational data (e.g., past job types, job details, work styles, return-to-work history). The proposal unit inputs these history data as time-series vectors (e.g., each history vectorized to 128 dimensions, with the most recent 30 records arranged) into the generative AI. Examples of input include “2024-06-01 Rehabilitation progress 60%”, “2024-06-02 Muscle strength measurement 28 kg”, “2024-06-03 Occupation: clerical work”, and so on. The proposal unit uses Transformer-based time-series analysis models or LSTM networks to extract patterns and perform clustering of history data, automatically learning the user's recovery trends, changes in health status, and transitions in occupational aptitude. AI outputs include selection of optimal proposal methods for the current situation (e.g., parameter optimization of progress prediction models, automatic adjustment of anomaly detection thresholds), comparison graphs with past data, and future prediction values (e.g., predicted muscle strength recovery value in two weeks). Examples of output include “Recommended proposal: exercise A three times a week, expected achievement 80%”, “Health management proposal: increase blood pressure measurement frequency”, “Occupational return proposal: desk work suitability 85%”, and so on. As a subsequent process, proposal results are linked to the user and the simulation unit, and are used to generate individually optimized target tasks and future scenarios based on the user's past data. As a technical effect, the proposal unit, unlike conventional static proposals or judgment based on human experience, realizes history pattern analysis by AI and automatic selection of individually optimized proposal methods, thereby providing clear technical effects such as improved proposal accuracy, earlier anomaly detection, individualized response for each user, and advanced decision support. Application fields include medical rehabilitation support systems, proposal support for persons with disabilities, business daily report proposals, educational learning record proposals, customer support history proposals, and many others.

The proposal unit can customize the content of proposals at the time of proposal based on the user's current physical condition. The proposal unit uses generative AI to customize the content of proposals at the time of proposal based on the user's current physical condition. Physical condition may include, for example, health status and exercise ability, but is not limited thereto. For example, when the user is tired, the proposal unit provides simplified proposals. When the user is relaxed, the proposal unit can provide detailed proposals. When the user feels stressed, the proposal unit can provide quick proposals. Thus, by customizing the content of proposals based on the user's current physical condition, the proposal unit can provide optimal proposals for the user. Specifically, the proposal unit acquires multidimensional numerical vectors (e.g., 128 dimensions) in real time, such as health status data input by the user (e.g., walking distance, muscle strength measurement, fatigue score, presence or absence of pain), exercise ability data (e.g., joint range of motion, activity level, balance score), and psychological state data (e.g., stress level, motivation, mood score). The proposal unit inputs these data into generative AI (e.g., multimodal large language model) to classify the user's state (e.g., fatigue, relaxation, stress) or score it (e.g., fatigue score 0.7, stress score 0.8). Examples of input include “Muscle strength: 25 kg, fatigue score: 0.8, stress score: 0.6”, “Mood: relaxed, pain: none”, and so on. Based on the AI output, the proposal unit automatically adjusts the number and detail level of proposal items, length of explanation, and types of options. For example, when the fatigue score is high, only minimal content such as “today's rehabilitation progress” or “presence or absence of pain” is displayed; when in a relaxed state, multiple items such as “detailed rehabilitation content”, “changes in living environment”, and “details of psychological state” are presented. When the stress score is high, the proposal unit narrows down the options and emphasizes only the main points to support quick decision-making. Examples of output include “Number of proposal items: 2, content: simple rehabilitation”, “Number of proposal items: 8, content: detailed rehabilitation +lifestyle improvement”, and so on. As a subsequent process, the proposal unit continuously monitors the user's proposal selection rate, implementation rate, required time, satisfaction, etc., and uses these to optimize AI model parameters and improve proposal content design. As a technical effect, the proposal unit, unlike conventional uniform proposals or subjective human judgment, realizes multidimensional state estimation by AI and real-time optimization of proposal content, thereby providing clear technical effects such as significant reduction of user burden, improved proposal efficiency, improved proposal accuracy, and enhanced user satisfaction. Application fields include medical rehabilitation support systems, proposal support for persons with disabilities, stress care applications, educational proposal systems, business daily report proposals, and many others.

The proposal unit can estimate the user's emotions and determine the priority of proposals based on the estimated emotions. The proposal unit uses generative AI to estimate the user's emotions and determine the priority of proposals based on the estimated emotions. The user's emotions may include, for example, impatience, relaxation, anxiety, and the like, but are not limited thereto. For example, when the user is impatient, the proposal unit preferentially displays important proposals. When the user is relaxed, the proposal unit can provide detailed proposals and offer many options. When the user feels anxious, the proposal unit can preferentially display proposals that give a sense of security. Thus, by determining the priority of proposals according to the user's emotions, the proposal unit can preferentially display important proposals. Emotion estimation is realized, for example, by using an emotion estimation function with an emotion engine or generative AI. The generative AI may be a text generative AI (e.g., LLM) or a multimodal generative AI, but is not limited thereto. Specifically, the proposal unit receives multimodal data such as natural language text input by the user (e.g., “I am in a hurry today”, “I feel anxious”), voice data (e.g., speech speed and tone), and facial images (e.g., face images captured by a camera). The proposal unit preprocesses these data: text is tokenized and vectorized, voice features are extracted, and facial features are extracted from images, and inputs them into a multimodal AI model (e.g., Transformer-based). The AI model outputs emotion classification (e.g., impatience, relaxation, anxiety) and emotion scores (e.g., impatience score 0.8, anxiety score 0.6). Examples of output include “Emotion: impatience, score 0.85”, “Emotion: relaxation, score 0.70”, and so on. Based on these outputs, the proposal unit automatically determines the priority of proposal items. For example, when the impatience score is high, “high urgency proposals (e.g., presence or absence of pain, rehabilitation progress)” are displayed at the top; when the relaxation score is high, “detailed proposals (e.g., living environment, psychological state)” are additionally displayed; when the anxiety score is high, “proposals that give a sense of security (e.g., support system, consultation desk)” are preferentially displayed. As a subsequent process, the proposal unit continuously monitors the user's proposal selection, implementation rate, required time, satisfaction, etc., and uses these to optimize AI model parameters and improve proposal item design. As a technical effect, the proposal unit, unlike conventional static proposals or priority assignment based on human experience, realizes multidimensional emotion estimation by AI and real-time priority control of proposal items, thereby providing clear technical effects such as improved proposal efficiency, reduced user burden, rapid acquisition of important information, and enhanced user satisfaction. Application fields include medical rehabilitation support systems, proposal support for persons with disabilities, stress care applications, educational proposal systems, customer support proposals, and many others.

The proposal unit can preferentially make highly relevant proposals at the time of proposal by considering the user's geographic location information. The proposal unit uses generative AI to preferentially make highly relevant proposals at the time of proposal by considering the user's geographic location information. Geographic location information may include, for example, GPS data and location information services, but is not limited thereto. For example, when the user is in a hospital, the proposal unit preferentially makes medical-related proposals. When the user is at home, the proposal unit can preferentially make rehabilitation-related proposals. When the user is outside, the proposal unit can preferentially make proposals related to movement. Thus, by considering the user's geographic location information, the proposal unit can preferentially make highly relevant proposals. Specifically, the proposal unit acquires GPS coordinate data (e.g., latitude 35.6895, longitude 139.6917, accuracy 5 m) obtained from user devices (e.g., smartphones, tablets, wearable devices), Wi-Fi/Bluetooth-based location information, and facility name/address information from location information service APIs as multidimensional vectors (e.g., 64-dimensional vectors including location coordinates, facility category, and time information) in real time. The proposal unit inputs these geographic location vectors into generative AI (e.g., multimodal Transformer model) and matches them with past usage history databases and facility attribute databases (e.g., labeled data for hospitals, rehabilitation facilities, homes, public transportation, commercial facilities, etc.). Examples of input include “Location: in hospital, time: 10 a.m.”, “Location: at home, time: 8 p.m.”, “Location: in station, time: 3 p.m.”, and so on. The generative AI calculates the similarity between the input location vector and the facility attribute database (e.g., cosine similarity, distance-based score) and automatically determines the most relevant scenario. Based on the determination result, the proposal unit automatically switches the priority and display format of proposal content (e.g., medical proposals prioritized, rehabilitation proposals prioritized, movement proposals prioritized). Examples of output include “Priority proposals: consultation details, medication status, next visit schedule (when staying in hospital)”, “Priority proposals: rehabilitation progress, daily activities, family support status (when staying at home)”, “Priority proposals: means of movement, movement distance, purpose of going out (when outside)”, and so on. As a subsequent process, feedback data such as the content of proposals actually selected and implemented by the user, completion rate, and required time are accumulated and used for continuous learning and optimization of the AI model. As a technical effect, the proposal unit, unlike conventional static proposals or item presentation based on human experience, realizes real-time geographic location estimation and multidimensional data analysis by AI, thereby automatically presenting proposal content optimized for the user's current location and usage scene. This provides clear technical effects such as improved proposal work efficiency, reduced erroneous proposals, reduced user burden, and increased system usage rate. Application fields include medical rehabilitation support systems, home care support, outing support applications, proposal assistance for persons with disabilities, business daily report proposals, mobile healthcare applications, and many others.

The proposal unit can analyze the user's social media activity at the time of proposal and make relevant proposals. The proposal unit uses generative AI to analyze the user's social media activity at the time of proposal and make relevant proposals. Social media activity may include, for example, post content and activity frequency, but is not limited thereto. For example, when the user posts about rehabilitation on social media, the proposal unit makes rehabilitation-related proposals. When the user posts about occupation on social media, the proposal unit can make occupation-related proposals. When the user posts about health on social media, the proposal unit can make health-related proposals. Thus, by analyzing the user's social media activity, the proposal unit can make relevant proposals. Specifically, the proposal unit collects post data (e.g., text posts, images, videos, post time, number of likes, number of comments, etc.) obtained from social media APIs within the scope permitted by the user in chronological order, and tokenizes and vectorizes the post content using a natural language processing engine (e.g., each post vectorized to 512 dimensions). Furthermore, to classify post frequency and post categories (e.g., rehabilitation, occupation, health, hobbies, family, travel, etc.), the proposal unit uses Transformer-based large language models or multimodal models to perform semantic analysis and sentiment analysis (e.g., positive, negative, neutral) of post content. Examples of input include “2024-06-01 ‘Working hard on rehabilitation’”, “2024-06-02 ‘Trying a new job’”, “2024-06-03 ‘Feeling well recently’”, and so on. Based on these analysis results, the proposal unit estimates the user's areas of interest and current living situation, and preferentially displays highly relevant proposals (e.g., rehabilitation progress, occupational preferences, health status, changes in living environment, etc.) on the input interface. Examples of output include “Recommended proposals: rehabilitation progress, exercise content”, “Recommended proposals: occupational preferences, work style”, “Recommended proposals: health status, medication status”, and so on. Furthermore, the proposal unit also considers post frequency and time pattern (e.g., frequent health posts at night) and automatically adjusts the display timing of proposal content and auxiliary functions (e.g., auto-completion, proposal candidate presentation). As a subsequent process, feedback data such as the content of proposals actually selected and implemented by the user, completion rate, required time, and satisfaction are accumulated and used for continuous learning and optimization of the AI model. As a technical effect, the proposal unit, unlike conventional static proposals or proposal support based on human experience, automates and accelerates social media activity analysis by AI and presentation of individually optimized proposal content, thereby providing clear technical effects such as improved proposal work efficiency, reduced erroneous proposals, reduced user burden, and increased system usage rate. Application fields include medical rehabilitation support systems, proposal assistance for persons with disabilities, business daily report proposals, educational learning record proposals, customer support proposals, personal healthcare applications, and many others.

The simulation unit can refer to the user's past data at the time of simulation to improve the accuracy of simulation. The simulation unit uses generative AI to refer to the user's past data at the time of simulation to improve the accuracy of simulation. Past data may include, for example, history data and log data, but are not limited thereto. For example, the simulation unit refers to the user's past rehabilitation data to perform optimal simulation for the current situation. The simulation unit can also refer to the user's past health data to improve the accuracy of simulation. Furthermore, the simulation unit can refer to the user's past occupational data to perform simulation regarding post-recovery occupations. Thus, by referring to the user's past data, the simulation unit improves the accuracy of simulation. Specifically, the simulation unit refers to structured databases such as rehabilitation history data recorded chronologically for each user (e.g., rehabilitation dates, exercise details, progress rate, achievement rate), health data (e.g., body temperature, blood pressure, heart rate, muscle strength measurements), and occupational data (e.g., past job types, job details, work styles, return-to-work history). The simulation unit inputs these history data as time-series vectors (e.g., each history vectorized to 128 dimensions, with the most recent 30 records arranged) into the generative AI. Examples of input include “2024-06-01 Rehabilitation progress 60%”, “2024-06-02 Muscle strength measurement 28 kg”, “2024-06-03 Occupation: clerical work”, and so on. The simulation unit uses Transformer-based time-series analysis models or LSTM networks to extract patterns and perform clustering of history data, automatically learning the user's recovery trends, changes in health status, and transitions in occupational aptitude. AI outputs include future scenario prediction values (e.g., predicted muscle strength recovery value in two weeks, return-to-work suitability score), comparison graphs with past data, and selection of optimal simulation methods (e.g., parameter optimization of progress prediction models, automatic adjustment of anomaly detection thresholds). Examples of output include “Simulation result: 80% recovery expected”, “Return-to-work aptitude: desk work suitability 85%”, and so on. Based on these outputs, the simulation unit presents future occupational/living scenarios and rehabilitation plan achievement prospects to the user in a dashboard format. As a subsequent process, scenarios selected by the user and feedback are fed back to the simulation unit and database unit, and the AI model is continuously learned and optimized. As a technical effect, the simulation unit, unlike conventional static simulations or judgment based on human experience, realizes history pattern analysis by AI and automatic selection of individually optimized simulation methods, thereby providing clear technical effects such as improved simulation accuracy, earlier anomaly detection, individualized response for each user, and advanced decision support. Application fields include medical rehabilitation support systems, simulation support for persons with disabilities, business return scenario generation, educational career simulation, customer support return-to-work support, and many others.

The simulation unit can customize the simulation method at the time of simulation based on the user's current physical condition. The simulation unit uses generative AI to customize the simulation method at the time of simulation based on the user's current physical condition. Physical condition may include, for example, health status and exercise ability, but is not limited thereto. For example, when the user is tired, the simulation unit uses a simplified simulation method. When the user is relaxed, the simulation unit can use a detailed simulation method. When the user feels stressed, the simulation unit can use a rapid simulation method. Thus, by customizing the simulation method based on the user's current physical condition, the simulation unit can provide optimal simulation results for the user. Specifically, the simulation unit acquires multidimensional numerical vectors (e.g., 128 dimensions) in real time, such as health status data input by the user (e.g., walking distance, muscle strength measurement, fatigue score, presence or absence of pain), exercise ability data (e.g., joint range of motion, activity level, balance score), and psychological state data (e.g., stress level, motivation, mood score). The simulation unit inputs these data into generative AI (e.g., multimodal large language model) to classify the user's state (e.g., fatigue, relaxation, stress) or score it (e.g., fatigue score 0.7, stress score 0.8). Examples of input include “Muscle strength: 25 kg, fatigue score: 0.8, stress score: 0.6”, “Mood: relaxed, pain: none”, and so on. Based on the AI output, the simulation unit automatically adjusts the selection of simulation methods and parameters (e.g., number of selected features, number of scenario branches, calculation batch size, threshold settings). For example, when the fatigue score is high, only major features are extracted, simple scenario branching and progress prediction models are applied to reduce computational load. When in a relaxed state, multi-stage simulation, detailed anomaly detection, and ensemble analysis of multiple models are performed to maximize accuracy. When the stress score is high, processing speed is prioritized and highly real-time inference models are selected. Examples of output include “Simulation method: simple branching, 5 major features”, “Simulation method: detailed multi-stage analysis, 20 features”, and so on. As a subsequent process, simulation results are linked to the user and the proposal unit, and are used for automatic adjustment of target tasks and future scenarios according to the user's physical condition. As a technical effect, the simulation unit, unlike conventional uniform simulation flows or subjective human judgment, realizes multidimensional state estimation by AI and real-time optimization of simulation methods, thereby providing clear technical effects such as significant reduction of user burden, improved simulation efficiency, improved simulation accuracy, and enhanced user satisfaction. Application fields include medical rehabilitation support systems, simulation support for persons with disabilities, stress care applications, educational scenario generation, business return simulation, and many others.

The simulation unit can estimate the user's emotions and determine the priority of simulation based on the estimated emotions. The simulation unit uses generative AI to estimate the user's emotions and determine the priority of simulation based on the estimated emotions. The user's emotions may include, for example, impatience, relaxation, anxiety, and the like, but are not limited thereto. For example, when the user is impatient, the simulation unit preferentially performs important simulations. When the user is relaxed, the simulation unit can provide detailed simulations and offer many options. When the user feels anxious, the simulation unit can preferentially perform simulations that give a sense of security. Thus, by determining the priority of simulation according to the user's emotions, the simulation unit can preferentially perform important simulations. Emotion estimation is realized, for example, by using an emotion estimation function with an emotion engine or generative AI. The generative AI may be a text generative AI (e.g., LLM) or a multimodal generative AI, but is not limited thereto. Specifically, the simulation unit receives multimodal data such as natural language text input by the user (e.g., “I am in a hurry today”, “I feel anxious”), voice data (e.g., speech speed and tone), and facial images (e.g., face images captured by a camera). The simulation unit preprocesses these data: text is tokenized and vectorized, voice features are extracted, and facial features are extracted from images, and inputs them into a multimodal AI model (e.g., Transformer-based). The AI model outputs emotion classification (e.g., impatience, relaxation, anxiety) and emotion scores (e.g., impatience score 0.8, anxiety score 0.6). Examples of output include “Emotion: impatience, score 0.85”, “Emotion: relaxation, score 0.70”, and so on. Based on these outputs, the simulation unit automatically determines the priority of simulation items. For example, when the impatience score is high, “high urgency simulations (e.g., presence or absence of pain, rehabilitation progress)” are displayed at the top; when the relaxation score is high, “detailed simulations (e.g., living environment, psychological state)” are additionally displayed; when the anxiety score is high, “simulations that give a sense of security (e.g., support system, consultation desk)” are preferentially displayed. As a subsequent process, the simulation unit continuously monitors the user's simulation selection, implementation rate, required time, satisfaction, etc., and uses these to optimize AI model parameters and improve simulation item design. As a technical effect, the simulation unit, unlike conventional static simulations or priority assignment based on human experience, realizes multidimensional emotion estimation by AI and real-time priority control of simulation items, thereby providing clear technical effects such as improved simulation efficiency, reduced user burden, rapid acquisition of important information, and enhanced user satisfaction. Application fields include medical rehabilitation support systems, simulation support for persons with disabilities, stress care applications, educational scenario generation, customer support simulation, and many others.

The simulation unit can preferentially perform highly relevant simulations at the time of simulation by considering the user's geographic location information. The simulation unit uses generative AI to preferentially perform highly relevant simulations at the time of simulation by considering the user's geographic location information. Geographic location information may include, for example, GPS data and location information services, but is not limited thereto. For example, when the user is in a hospital, the simulation unit preferentially performs medical-related simulations. When the user is at home, the simulation unit can preferentially perform rehabilitation-related simulations. When the user is outside, the simulation unit can preferentially perform simulations related to movement. Thus, by considering the user's geographic location information, the simulation unit can preferentially perform highly relevant simulations. Specifically, the simulation unit acquires GPS coordinate data (e.g., latitude 35.6895, longitude 139.6917, accuracy 5 m) obtained from user devices (e.g., smartphones, tablets, wearable devices), Wi-Fi/Bluetooth-based location information, and facility name/address information from location information service APIs as multidimensional vectors (e.g., 64-dimensional vectors including location coordinates, facility category, and time information) in real time. The simulation unit inputs these geographic location vectors into generative AI (e.g., multimodal Transformer model) and matches them with past usage history databases and facility attribute databases (e.g., labeled data for hospitals, rehabilitation facilities, homes, public transportation, commercial facilities, etc.). Examples of input include “Location: in hospital, time: 10 a.m.”, “Location: at home, time: 8 p.m.”, “Location: in station, time: 3 p.m.”, and so on. The generative AI calculates the similarity between the input location vector and the facility attribute database (e.g., cosine similarity, distance-based score) and automatically determines the most relevant scenario. Based on the determination result, the simulation unit automatically switches the priority and display format of simulation content (e.g., medical simulation prioritized, rehabilitation simulation prioritized, movement simulation prioritized). Examples of output include “Priority simulation: consultation details, medication status, next visit schedule (when staying in hospital)”, “Priority simulation: rehabilitation progress, daily activities, family support status (when staying at home)”, “Priority simulation: means of movement, movement distance, purpose of going out (when outside)”, and so on. As a subsequent process, feedback data such as the content of simulations actually selected and implemented by the user, completion rate, and required time are accumulated and used for continuous learning and optimization of the AI model. As a technical effect, the simulation unit, unlike conventional static simulations or item presentation based on human experience, realizes real-time geographic location estimation and multidimensional data analysis by AI, thereby automatically presenting simulation content optimized for the user's current location and usage scene. This provides clear technical effects such as improved simulation work efficiency, reduced erroneous simulations, reduced user burden, and increased system usage rate. Application fields include medical rehabilitation support systems, home care support, outing support applications, simulation assistance for persons with disabilities, business return simulation, mobile healthcare applications, and many others.

The simulation unit can analyze the user's social media activity at the time of simulation and perform relevant simulations. The simulation unit uses generative AI to analyze the user's social media activity at the time of simulation and perform relevant simulations. Social media activity may include, for example, post content and activity frequency, but is not limited thereto. For example, when the user posts about rehabilitation on social media, the simulation unit performs rehabilitation-related simulations. When the user posts about occupation on social media, the simulation unit can perform occupation-related simulations. When the user posts about health on social media, the simulation unit can perform health-related simulations. Thus, by analyzing the user's social media activity, the simulation unit can perform relevant simulations. Specifically, the simulation unit collects post data (e.g., text posts, images, videos, post time, number of likes, number of comments, etc.) obtained from social media APIs within the scope permitted by the user in chronological order, and tokenizes and vectorizes the post content using a natural language processing engine (e.g., each post vectorized to 512 dimensions). Furthermore, to classify post frequency and post categories (e.g., rehabilitation, occupation, health, hobbies, family, travel, etc.), the simulation unit uses Transformer-based large language models or multimodal models to perform semantic analysis and sentiment analysis (e.g., positive, negative, neutral) of post content. Examples of input include “2024-06-01 ‘Working hard on rehabilitation’”, “2024-06-02 ‘Trying a new job’”, “2024-06-03 ‘Feeling well recently’”, and so on. Based on these analysis results, the simulation unit estimates the user's areas of interest and current living situation, and preferentially executes highly relevant simulations (e.g., rehabilitation progress, occupational preferences, health status, changes in living environment, etc.). AI outputs include “Recommended simulation: rehabilitation progress prediction, exercise content scenario”, “Recommended simulation: occupational return scenario, work style simulation”, “Recommended simulation: health status prediction, medication management scenario”, and so on. Furthermore, the simulation unit also considers post frequency and time pattern (e.g., frequent health posts at night) and automatically adjusts the display timing of simulation content and auxiliary functions (e.g., auto-completion, scenario candidate presentation). As a subsequent process, feedback data such as the content of simulations actually selected and implemented by the user, completion rate, required time, and satisfaction are accumulated and used for continuous learning and optimization of the AI model. As a technical effect, the simulation unit, unlike conventional static simulations or scenario presentation based on human experience, automates and accelerates social media activity analysis by AI and presentation of individually optimized simulation content, thereby providing clear technical effects such as improved simulation work efficiency, reduced erroneous simulations, reduced user burden, and increased system usage rate. Application fields include medical rehabilitation support systems, simulation assistance for persons with disabilities, business return scenario generation, educational learning record simulation, customer support scenario generation, personal healthcare applications, and many others.

The monitoring unit can estimate the user's emotions and adjust the monitoring frequency based on the estimated emotions. The monitoring unit uses generative AI to estimate the user's emotions and adjust the monitoring frequency based on the estimated emotions. The user's emotions may include, for example, anxiety, relaxation, impatience, and the like, but are not limited thereto. For example, when the user feels anxious, the monitoring unit performs frequent monitoring to provide a sense of security. When the user is relaxed, the monitoring unit can reduce the monitoring frequency to alleviate stress. When the user is impatient, the monitoring unit can perform rapid monitoring and provide results quickly. Thus, by adjusting the monitoring frequency according to the user's emotions, the monitoring unit can provide a sense of security to the user. Emotion estimation is realized, for example, by using an emotion estimation function with an emotion engine or generative AI. The generative AI may be a text generative AI (e.g., LLM) or a multimodal generative AI, but is not limited thereto. Specifically, the monitoring unit receives multimodal data such as natural language text input by the user (e.g., “I feel anxious recently”, “I am calm today”), voice data (e.g., speech speed and tone), and facial images (e.g., face images captured by a camera). The monitoring unit preprocesses these data: text is tokenized and vectorized (e.g., 512-dimensional vector), voice features are extracted using MFCC, and facial features are extracted from images (e.g., 68-point landmarks). Examples of input include “Speech text: ‘I am anxious today’”, “Voice data with low tone”, “Smiling face image”, and so on. The monitoring unit inputs these multimodal feature vectors into a multimodal Transformer or a large language model with self-attention mechanism, and outputs emotion classification (e.g., labels such as anxiety, relaxation, impatience) and emotion scores (e.g., anxiety score 0.8, relaxation score 0.2 as probability distribution). Examples of output include “Emotion label: anxiety, score 0.75”, “Emotion label: relaxation, score 0.60”, and so on. Based on these output results, the monitoring unit automatically adjusts the monitoring frequency. For example, when the anxiety score is high, the frequency is increased, such as “monitor health status every 5 minutes” or “monitor vital signs in real time”; when the relaxation score is high, the frequency is reduced, such as “simple monitoring once a day” or “weekly report only”; when the impatience score is high, rapid response is provided, such as “immediate monitoring” or “instant notification of results”. As a subsequent process, monitoring results and user reactions (e.g., sense of security feedback, re-monitoring requests, changes in stress score) are continuously collected and used to optimize AI model parameters and improve monitoring design. As a technical effect, the monitoring unit, unlike conventional uniform monitoring schedules or subjective human judgment, realizes multidimensional emotion estimation by AI and real-time optimization of monitoring frequency, thereby providing clear technical effects such as reduction of psychological burden on the user, improved sense of security, improved monitoring efficiency, and reduced false detection. Application fields include medical rehabilitation support systems, health monitoring for persons with disabilities, stress care applications, educational monitoring systems, customer support monitoring, and many others.

The monitoring unit can refer to the user's past data at the time of monitoring to improve the accuracy of monitoring. The monitoring unit uses generative AI to refer to the user's past data at the time of monitoring to improve the accuracy of monitoring. Past data may include, for example, history data and log data, but are not limited thereto. For example, the monitoring unit refers to the user's past rehabilitation data to perform optimal monitoring for the current situation. The monitoring unit can also refer to the user's past health data to improve the accuracy of monitoring. Furthermore, the monitoring unit can refer to the user's past occupational data to perform monitoring regarding post-recovery occupations. Thus, by referring to the user's past data, the monitoring unit improves the accuracy of monitoring. Specifically, the monitoring unit refers to structured databases such as rehabilitation history data recorded chronologically for each user (e.g., rehabilitation dates, exercise details, progress rate, achievement rate), health data (e.g., body temperature, blood pressure, heart rate, muscle strength measurements), and occupational data (e.g., past job types, job details, work styles, return-to-work history). The monitoring unit inputs these history data as time-series vectors (e.g., each history vectorized to 128 dimensions, with the most recent 30 records arranged) into the generative AI. Examples of input include “2024-06-01 Rehabilitation progress 60%”, “2024-06-02 Muscle strength measurement 28 kg”, “2024-06-03 Occupation: clerical work”, and so on. The monitoring unit uses Transformer-based time-series analysis models or LSTM networks to extract patterns and perform clustering of history data, automatically learning the user's recovery trends, changes in health status, and transitions in occupational aptitude. AI outputs include selection of optimal monitoring methods for the current situation (e.g., parameter optimization of progress prediction models, automatic adjustment of anomaly detection thresholds), comparison graphs with past data, and future prediction values (e.g., predicted muscle strength recovery value in two weeks). Examples of output include “Progress prediction: 80% achievement expected”, “Health status: stable”, “Occupational aptitude: desk work suitability 85%”, and so on. Based on these outputs, the monitoring unit automatically adjusts monitoring frequency, target items, alert thresholds, and so on. As a subsequent process, monitoring results and user reactions (e.g., response to anomaly detection, feedback, re-monitoring requests) are continuously collected and used to optimize AI model parameters and improve monitoring design. As a technical effect, the monitoring unit, unlike conventional static monitoring or judgment based on human experience, realizes history pattern analysis by AI and automatic selection of individually optimized monitoring methods, thereby providing clear technical effects such as improved monitoring accuracy, earlier anomaly detection, individualized response for each user, and improved sense of security. Application fields include medical rehabilitation support systems, monitoring support for persons with disabilities, business daily report monitoring, educational learning record monitoring, customer support history monitoring, and many others.

The monitoring unit can estimate the user's emotions and determine the priority of monitoring based on the estimated emotions. The monitoring unit uses generative AI to estimate the user's emotions and determine the priority of monitoring based on the estimated emotions. The user's emotions may include, for example, impatience, relaxation, anxiety, and the like, but are not limited thereto. For example, when the user is impatient, the monitoring unit preferentially performs important monitoring. When the user is relaxed, the monitoring unit can provide detailed monitoring and offer many options. When the user feels anxious, the monitoring unit can preferentially perform monitoring that gives a sense of security. Thus, by determining the priority of monitoring according to the user's emotions, the monitoring unit can preferentially perform important monitoring. Emotion estimation is realized, for example, by using an emotion estimation function with an emotion engine or generative AI. The generative AI may be a text generative AI (e.g., LLM) or a multimodal generative AI, but is not limited thereto. Specifically, the monitoring unit receives multimodal data such as natural language text input by the user (e.g., “I am in a hurry today”, “I feel anxious”), voice data (e.g., speech speed and tone), and facial images (e.g., face images captured by a camera). The monitoring unit preprocesses these data: text is tokenized and vectorized, voice features are extracted, and facial features are extracted from images, and inputs them into a multimodal AI model (e.g., Transformer-based). The AI model outputs emotion classification (e.g., impatience, relaxation, anxiety) and emotion scores (e.g., impatience score 0.8, anxiety score 0.6). Examples of output include “Emotion: impatience, score 0.85”, “Emotion: relaxation, score 0.70”, and so on. Based on these outputs, the monitoring unit automatically determines the priority of monitoring items. For example, when the impatience score is high, “high urgency monitoring (e.g., vital signs, presence or absence of pain)” is displayed at the top; when the relaxation score is high, “detailed monitoring (e.g., living environment, psychological state)” is additionally displayed; when the anxiety score is high, “monitoring that gives a sense of security (e.g., support system, consultation desk)” is preferentially displayed. As a subsequent process, the monitoring unit continuously monitors the user's monitoring selection, completion rate, required time, sense of security, etc., and uses these to optimize AI model parameters and improve monitoring item design. As a technical effect, the monitoring unit, unlike conventional static monitoring or priority assignment based on human experience, realizes multidimensional emotion estimation by AI and real-time priority control of monitoring items, thereby providing clear technical effects such as improved monitoring efficiency, reduced user burden, rapid acquisition of important information, and improved sense of security. Application fields include medical rehabilitation support systems, monitoring support for persons with disabilities, stress care applications, educational monitoring systems, customer support monitoring, and many others.

The monitoring unit can preferentially perform highly relevant monitoring at the time of monitoring by considering the user's geographic location information. The monitoring unit uses generative AI to preferentially perform highly relevant monitoring at the time of monitoring by considering the user's geographic location information. Geographic location information may include, for example, GPS data and location information services, but is not limited thereto. For example, when the user is in a hospital, the monitoring unit preferentially performs medical-related monitoring. When the user is at home, the monitoring unit can preferentially perform rehabilitation-related monitoring. When the user is outside, the monitoring unit can preferentially perform monitoring related to movement. Thus, by considering the user's geographic location information, the monitoring unit can preferentially perform highly relevant monitoring. Specifically, the monitoring unit acquires GPS coordinate data (e.g., latitude 35.6895, longitude 139.6917, accuracy 5 m) obtained from user devices (e.g., smartphones, tablets, wearable devices), Wi-Fi/Bluetooth-based location information, and facility name/address information from location information service APIs as multidimensional vectors (e.g., 64-dimensional vectors including location coordinates, facility category, and time information) in real time. The monitoring unit inputs these geographic location vectors into generative AI (e.g., multimodal Transformer model) and matches them with past usage history databases and facility attribute databases (e.g., labeled data for hospitals, rehabilitation facilities, homes, public transportation, commercial facilities, etc.). Examples of input include “Location: in hospital, time: 10 a.m.”, “Location: at home, time: 8 p.m.”, “Location: in station, time: 3 p.m.”, and so on. The generative AI calculates the similarity between the input location vector and the facility attribute database (e.g., cosine similarity, distance-based score) and automatically determines the most relevant monitoring scenario. Based on the determination result, the monitoring unit automatically switches the priority of monitoring target data and monitoring methods (e.g., medical data priority monitoring, rehabilitation data priority monitoring, movement data priority monitoring). Examples of output include “Monitoring target: medical data, priority 90%”, “Monitoring target: rehabilitation data, priority 80%”, and so on. As a subsequent process, monitoring results are linked to the user and the analysis unit, and are used for individually optimized monitoring design and alert generation according to the user's geographic location. As a technical effect, the monitoring unit, unlike conventional static monitoring or judgment based on human experience, realizes real-time geographic location estimation and multidimensional data analysis by AI, thereby automating and improving the accuracy of monitoring optimized for the user's current location and usage scene. This provides clear technical effects such as improved monitoring efficiency, reduced erroneous monitoring, reduced user burden, and increased system usage rate. Application fields include medical rehabilitation support systems, home care support, outing support applications, monitoring assistance for persons with disabilities, business daily report monitoring, mobile healthcare applications, and many others.

The generation unit can estimate the user's emotions and adjust the generation algorithm based on the estimated emotions. The generation unit uses generative AI to estimate the user's emotions and adjust the generation algorithm based on the estimated emotions. The user's emotions may include, for example, relaxation, impatience, anxiety, and the like, but are not limited thereto. For example, when the user is relaxed, the generation unit performs detailed generation to improve accuracy. When the user is impatient, the generation unit can perform rapid generation and provide results quickly. When the user feels anxious, the generation unit can provide generation results that give a sense of security. Thus, by adjusting the generation algorithm according to the user's emotions, the generation unit improves the accuracy of generation results. Emotion estimation is realized, for example, by using an emotion estimation function with an emotion engine or generative AI. The generative AI may be a text generative AI (e.g., LLM) or a multimodal generative AI, but is not limited thereto. Specifically, the generation unit receives multimodal data such as natural language text input by the user (e.g., “I am calm today”, “I feel anxious”), voice data (e.g., speech speed and tone), and facial images (e.g., face images captured by a camera). The generation unit preprocesses these data: text is tokenized and vectorized (e.g., 512-dimensional vector), voice features are extracted using MFCC, and facial features are extracted from images (e.g., 68-point landmarks). Examples of input include “Speech text: ‘I am relaxed today’”, “Voice data with high tone”, “Smiling face image”, and so on. The generation unit inputs these multimodal feature vectors into a multimodal Transformer or a large language model with self-attention mechanism, and outputs emotion classification (e.g., labels such as relaxation, impatience, anxiety) and emotion scores (e.g., relaxation score 0.7, impatience score 0.2, anxiety score 0.1 as probability distribution). Examples of output include “Emotion label: relaxation, score 0.75”, “Emotion label: impatience, score 0.60”, and so on. Based on these output results, the generation unit automatically adjusts the parameters of the generation algorithm (e.g., generation depth, number of selected features, processing batch size, threshold settings). For example, when the relaxation score is high, detailed feature extraction and multi-stage generation are performed to maximize generation accuracy. When the impatience score is high, features are narrowed down and the number of inferences is reduced to prioritize speed. When the anxiety score is high, the generation result emphasizes interpretability and a sense of security, highlighting interpretable features and comparison results with past success stories. As a subsequent process, generation results are linked to the proposal unit and simulation unit, and are used for automatic adjustment of target tasks and future scenarios according to the user's emotional state. As a technical effect, the generation unit, unlike conventional uniform generation flows or subjective human judgment, realizes multidimensional emotion estimation by AI and real-time optimization of the generation algorithm, thereby providing clear technical effects such as improved generation accuracy, optimized processing speed, reduced psychological burden on the user, and improved interpretability. Application fields include medical rehabilitation support systems, generation support for persons with disabilities, stress care applications, educational generation systems, customer support generation, and many others.

The generation unit can refer to the user's past data at the time of generation to improve the accuracy of generation. The generation unit uses generative AI to refer to the user's past data at the time of generation to improve the accuracy of generation. Past data may include, for example, history data and log data, but are not limited thereto. For example, the generation unit refers to the user's past rehabilitation data to perform optimal generation for the current situation. The generation unit can also refer to the user's past health data to improve the accuracy of generation. Furthermore, the generation unit can refer to the user's past occupational data to perform generation regarding post-recovery occupations. Thus, by referring to the user's past data, the generation unit improves the accuracy of generation. Specifically, the generation unit refers to structured databases such as rehabilitation history data recorded chronologically for each user (e.g., rehabilitation dates, exercise details, progress rate, achievement rate), health data (e.g., body temperature, blood pressure, heart rate, muscle strength measurements), and occupational data (e.g., past job types, job details, work styles, return-to-work history). The generation unit inputs these history data as time-series vectors (e.g., each history vectorized to 128 dimensions, with the most recent 30 records arranged) into the generative AI. Examples of input include “2024-06-01 Rehabilitation progress 60%”, “2024-06-02 Muscle strength measurement 28 kg”, “2024-06-03 Occupation: clerical work”, and so on. The generation unit uses Transformer-based time-series analysis models or LSTM networks to extract patterns and perform clustering of history data, automatically learning the user's recovery trends, changes in health status, and transitions in occupational aptitude. AI outputs include selection of optimal generation methods for the current situation (e.g., parameter optimization of progress prediction models, automatic adjustment of anomaly detection thresholds), comparison graphs with past data, and future prediction values (e.g., predicted muscle strength recovery value in two weeks). Examples of output include “Generation result: exercise A three times a week, expected achievement 80%”, “Generation result: health management proposal, increase blood pressure measurement frequency”, “Generation result: occupational return scenario, desk work suitability 85%”, and so on. As a subsequent process, generation results are linked to the proposal unit and simulation unit, and are used to generate individually optimized target tasks and future scenarios based on the user's past data. As a technical effect, the generation unit, unlike conventional static generation or judgment based on human experience, realizes history pattern analysis by AI and automatic selection of individually optimized generation methods, thereby providing clear technical effects such as improved generation accuracy, earlier anomaly detection, individualized response for each user, and advanced decision support. Application fields include medical rehabilitation support systems, generation support for persons with disabilities, business daily report generation, educational learning record generation, customer support history generation, and many others.

The generation unit can estimate the user's emotions and determine the priority of generation based on the estimated emotions. The generation unit uses generative AI to estimate the user's emotions and determine the priority of generation based on the estimated emotions. The user's emotions may include, for example, impatience, relaxation, anxiety, and the like, but are not limited thereto. For example, when the user is impatient, the generation unit preferentially performs important generation. When the user is relaxed, the generation unit can provide detailed generation and offer many options. When the user feels anxious, the generation unit can preferentially perform generation that gives a sense of security. Thus, by determining the priority of generation according to the user's emotions, the generation unit can preferentially perform important generation. Emotion estimation is realized, for example, by using an emotion estimation function with an emotion engine or generative AI. The generative AI may be a text generative AI (e.g., LLM) or a multimodal generative AI, but is not limited thereto. Specifically, the generation unit receives multimodal data such as natural language text input by the user (e.g., “I am in a hurry today”, “I feel anxious”), voice data (e.g., speech speed and tone), and facial images (e.g., face images captured by a camera). The generation unit preprocesses these data: text is tokenized and vectorized, voice features are extracted, and facial features are extracted from images, and inputs them into a multimodal AI model (e.g., Transformer-based). The AI model outputs emotion classification (e.g., impatience, relaxation, anxiety) and emotion scores (e.g., impatience score 0.8, anxiety score 0.6). Examples of output include “Emotion: impatience, score 0.85”, “Emotion: relaxation, score 0.70”, and so on. Based on these outputs, the generation unit automatically determines the priority of generation items. For example, when the impatience score is high, “high urgency generation (e.g., presence or absence of pain, rehabilitation progress)” is displayed at the top; when the relaxation score is high, “detailed generation (e.g., living environment, psychological state)” is additionally displayed; when the anxiety score is high, “generation that gives a sense of security (e.g., support system, consultation desk)” is preferentially displayed. As a subsequent process, the generation unit continuously monitors the user's generation selection, implementation rate, required time, satisfaction, etc., and uses these to optimize AI model parameters and improve generation item design. As a technical effect, the generation unit, unlike conventional static generation or priority assignment based on human experience, realizes multidimensional emotion estimation by AI and real-time priority control of generation items, thereby providing clear technical effects such as improved generation efficiency, reduced user burden, rapid acquisition of important information, and enhanced user satisfaction. Application fields include medical rehabilitation support systems, generation support for persons with disabilities, stress care applications, educational generation systems, customer support generation, and many others.

The generation unit can preferentially perform highly relevant generation at the time of generation by considering the user's geographic location information. The generation unit uses generative AI to preferentially perform highly relevant generation at the time of generation by considering the user's geographic location information. Geographic location information may include, for example, GPS data and location information services, but is not limited thereto. For example, when the user is in a hospital, the generation unit preferentially performs medical-related generation. When the user is at home, the generation unit can preferentially perform rehabilitation-related generation. When the user is outside, the generation unit can preferentially perform generation related to movement. Thus, by considering the user's geographic location information, the generation unit can preferentially perform highly relevant generation. Specifically, the generation unit acquires GPS coordinate data (e.g., latitude 35.6895, longitude 139.6917, accuracy 5 m) obtained from user devices (e.g., smartphones, tablets, wearable devices), Wi-Fi/Bluetooth-based location information, and facility name/address information from location information service APIs as multidimensional vectors (e.g., 64-dimensional vectors including location coordinates, facility category, and time information) in real time. The generation unit inputs these geographic location vectors into generative AI (e.g., multimodal Transformer model) and matches them with past usage history databases and facility attribute databases (e.g., labeled data for hospitals, rehabilitation facilities, homes, public transportation, commercial facilities, etc.). Examples of input include “Location: in hospital, time: 10 a.m.”, “Location: at home, time: 8 p.m.”, “Location: in station, time: 3 p.m.”, and so on. The generative AI calculates the similarity between the input location vector and the facility attribute database (e.g., cosine similarity, distance-based score) and automatically determines the most relevant scenario. Based on the determination result, the generation unit automatically switches the priority and display format of generation content (e.g., medical generation prioritized, rehabilitation generation prioritized, movement generation prioritized). Examples of output include “Priority generation: consultation details, medication status, next visit schedule (when staying in hospital)”, “Priority generation: rehabilitation progress, daily activities, family support status (when staying at home)”, “Priority generation: means of movement, movement distance, purpose of going out (when outside)”, and so on. As a subsequent process, feedback data such as the content of generation actually selected and implemented by the user, completion rate, and required time are accumulated and used for continuous learning and optimization of the AI model. As a technical effect, the generation unit, unlike conventional static generation or item presentation based on human experience, realizes real-time geographic location estimation and multidimensional data analysis by AI, thereby automatically presenting generation content optimized for the user's current location and usage scene. This provides clear technical effects such as improved generation work efficiency, reduced erroneous generation, reduced user burden, and increased system usage rate. Application fields include medical rehabilitation support systems, home care support, outing support applications, generation assistance for persons with disabilities, business daily report generation, mobile healthcare applications, and many others.

The database unit can estimate the user's emotions and adjust the search results of the database based on the estimated emotions. The database unit uses generative AI to estimate the user's emotions and adjust the search results of the database based on the estimated emotions. The user's emotions may include, for example, anxiety, relaxation, impatience, and the like, but are not limited thereto. For example, when the user feels anxious, the database unit preferentially displays search results that give a sense of security. When the user is relaxed, the database unit can provide detailed search results and offer many options. When the user is impatient, the database unit can preferentially display important search results. Thus, by adjusting the search results of the database according to the user's emotions, the database unit can provide optimal search results for the user. Emotion estimation is realized, for example, by using an emotion estimation function with an emotion engine or generative AI. The generative AI may be a text generative AI (e.g., LLM) or a multimodal generative AI, but is not limited thereto.

The database unit can refer to the user's past data during database updates to improve the accuracy of updates. The database unit uses generative AI to refer to the user's past data during database updates to improve update accuracy. Past data may include, for example, history data or log data, but is not limited thereto. For example, the database unit may refer to the user's past rehabilitation data and update the data to be optimal for the current situation. In addition, the database unit may refer to the user's past health data to improve the accuracy of updates. Furthermore, the database unit may refer to the user's past occupation data to update data related to post-recovery occupations. Thus, by referring to the user's past data, the database unit improves the accuracy of database updates.

The database unit can estimate the user's emotions and determine the search priority of the database based on the estimated emotions. The database unit uses generative AI to estimate the user's emotions and determine the search priority of the database based on the estimated emotions. The user's emotions may include, for example, impatience, relaxation, anxiety, and the like, but are not limited thereto. For example, when the user is impatient, the database unit preferentially displays important search results. When the user is relaxed, the database unit may provide detailed search results and increase the number of options. Furthermore, when the user feels anxious, the database unit may preferentially display search results that provide a sense of security. Thus, by determining the search priority of the database according to the user's emotions, the database unit can preferentially display important search results. Emotion estimation may be realized by using an emotion engine or emotion estimation function utilizing generative AI, for example. The generative AI may be a text generative AI (such as an LLM) or a multimodal generative AI, but is not limited thereto.

The database unit can preferentially update highly relevant data during database updates by considering the user's geographic location information. The database unit uses generative AI to preferentially update highly relevant data during database updates by considering the user's geographic location information. Geographic location information may include, for example, GPS data or location information services, but is not limited thereto. For example, when the user is in a hospital, the database unit preferentially updates medical-related data. When the user is at home, the database unit may preferentially update rehabilitation-related data. Furthermore, when the user is outside, the database unit may preferentially update data related to movement. Thus, by considering the user's geographic location information, the database unit can preferentially update highly relevant data.

The system according to the embodiment is not limited to the examples described above, and various modifications are possible, for example, as follows.

The reception unit can estimate the user's emotions and adjust the display method of the input interface based on the estimated emotions. For example, when the user feels anxious, a calm-colored interface is provided to give a sense of security. When the user is relaxed, a brightly colored interface is provided to make the input task enjoyable. Furthermore, when the user is impatient, a simple and highly visible interface is provided to enable quick input. Thus, by adjusting the display method of the input interface according to the user's emotions, the reception unit can make the user's input task comfortable.

The monitoring unit can not only monitor the user's rehabilitation progress, but also estimate the user's emotions and adjust the frequency of monitoring based on the estimated emotions. For example, when the user feels anxious, monitoring is performed frequently to provide a sense of security. When the user is relaxed, the frequency of monitoring may be reduced to alleviate stress. Furthermore, when the user is impatient, monitoring may be performed quickly to provide results promptly. Thus, by adjusting the frequency of monitoring according to the user's emotions, the monitoring unit can provide a sense of security to the user.

The generation unit can estimate the user's emotions and adjust the generation algorithm based on the estimated emotions. For example, when the user is relaxed, detailed generation is performed to improve accuracy. When the user is impatient, rapid generation may be performed to provide results quickly. Furthermore, when the user feels anxious, generation results that provide a sense of security may be provided. Thus, by adjusting the generation algorithm according to the user's emotions, the generation unit improves the accuracy of generation results.

The proposal unit can estimate the user's emotions and adjust the expression method of proposals based on the estimated emotions. For example, when the user is relaxed, detailed proposals are made and more options are provided. When the user is impatient, concise proposals may be made to provide options quickly. Furthermore, when the user feels anxious, proposals that provide a sense of security may be made and the number of options may be reduced. Thus, by adjusting the expression method of proposals according to the user's emotions, the proposal unit can provide proposals that are easy for the user to understand.

The database unit can estimate the user's emotions and adjust the search results of the database based on the estimated emotions. For example, when the user feels anxious, search results that provide a sense of security are preferentially displayed. When the user is relaxed, detailed search results may be provided and more options may be offered. Furthermore, when the user is impatient, important search results may be preferentially displayed. Thus, by adjusting the search results of the database according to the user's emotions, the database unit can provide optimal search results for the user.

The reception unit can analyze the user's past input history and propose an appropriate input method. For example, information that the user has frequently input in the past is automatically displayed as a candidate. In addition, input methods (such as voice or text) that the user has used in the past may be preferentially proposed. Furthermore, based on the user's past input history, information used at specific times of day may be predicted and proposed. Thus, by analyzing the user's past input history, the reception unit can propose the optimal input method.

The analysis unit can refer to the user's past data during analysis to improve the accuracy of analysis. For example, the user's past rehabilitation data may be referred to in order to perform analysis optimal for the current situation. In addition, the user's past health data may be referred to in order to improve the accuracy of analysis. Furthermore, the user's past occupation data may be referred to in order to perform analysis related to post-recovery occupations. Thus, by referring to the user's past data, the analysis unit improves the accuracy of analysis.

The proposal unit can refer to the user's past data during proposal to improve the accuracy of proposals. For example, the user's past rehabilitation data may be referred to in order to make proposals optimal for the current situation. In addition, the user's past health data may be referred to in order to improve the accuracy of proposals. Furthermore, the user's past occupation data may be referred to in order to make proposals related to post-recovery occupations. Thus, by referring to the user's past data, the proposal unit improves the accuracy of proposals.

The simulation unit can refer to the user's past data during simulation to improve the accuracy of simulation. For example, the user's past rehabilitation data may be referred to in order to perform simulation optimal for the current situation. In addition, the user's past health data may be referred to in order to improve the accuracy of simulation. Furthermore, the user's past occupation data may be referred to in order to perform simulation related to post-recovery occupations. Thus, by referring to the user's past data, the simulation unit improves the accuracy of simulation.

The monitoring unit can refer to the user's past data during monitoring to improve the accuracy of monitoring. For example, the user's past rehabilitation data may be referred to in order to perform monitoring optimal for the current situation. In addition, the user's past health data may be referred to in order to improve the accuracy of monitoring. Furthermore, the user's past occupation data may be referred to in order to perform monitoring related to post-recovery occupations. Thus, by referring to the user's past data, the monitoring unit improves the accuracy of monitoring.

The following is a brief description of the processing flow of Example of the Embodiment.
Step 1: The reception unit inputs the user's status. The user's status may include, for example, health condition, living environment, psychological state, and the like. The reception unit inputs information such as the user being hospitalized due to a fracture, the progress of rehabilitation, and the occupation or lifestyle aimed for after recovery.
Step 2: The analysis unit uses generative AI to analyze the information input by the reception unit. The analysis is performed based on data analysis techniques and algorithms used. For example, generative AI analyzes the user's status using machine learning models or data generation algorithms.
Step 3: The proposal unit uses generative AI to propose a target task based on the information analyzed by the analysis unit. The target task may include, for example, rehabilitation goals or learning goals. Generative AI generates an optimal target task for the user's status based on past data and similar cases.
Step 4: The simulation unit uses generative AI to simulate the post-recovery position based on the target task proposed by the proposal unit. The simulation is performed based on simulation models and data used. Generative AI simulates post-recovery occupations and lifestyles based on the user's goals and preferences, and presents optimal options.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the aforementioned elements, including the reception unit, analysis unit, proposal unit, simulation unit, monitoring unit, generation unit, and database unit, is implemented by at least one of, for example, the smart device 14 and the data processing apparatus 12. For example, the reception unit is implemented by a control unit 46A of the smart device 14 and inputs a user's status. The analysis unit is implemented, for example, by a specific processing unit 290 of the data processing apparatus 12 and analyzes input information using a generative AI. The proposal unit is implemented, for example, by the specific processing unit 290 of the data processing apparatus 12 and proposes a target task based on the analyzed information. The simulation unit is implemented, for example, by the specific processing unit 290 of the data processing apparatus 12 and simulates a post-recovery position based on the proposed target task. The monitoring unit is implemented, for example, by the control unit 46A of the smart device 14 and monitors the user's rehabilitation progress. The generation unit is implemented, for example, by the specific processing unit 290 of the data processing apparatus 12 and generates an appropriate target task based on past data and similar cases. The database unit is implemented, for example, by a database 24 of the data processing apparatus 12 and provides a database utilized by the generative AI when simulating post-recovery occupations and lifestyles. The correspondence between each unit and the apparatus or control unit is not limited to the examples described above and various modifications are possible.

### Second Embodiment

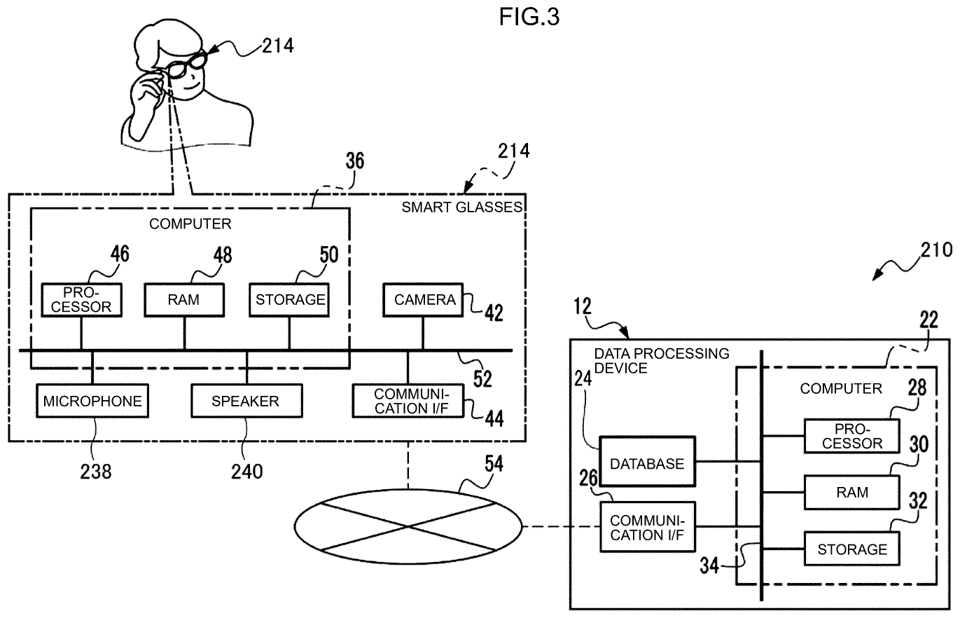

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

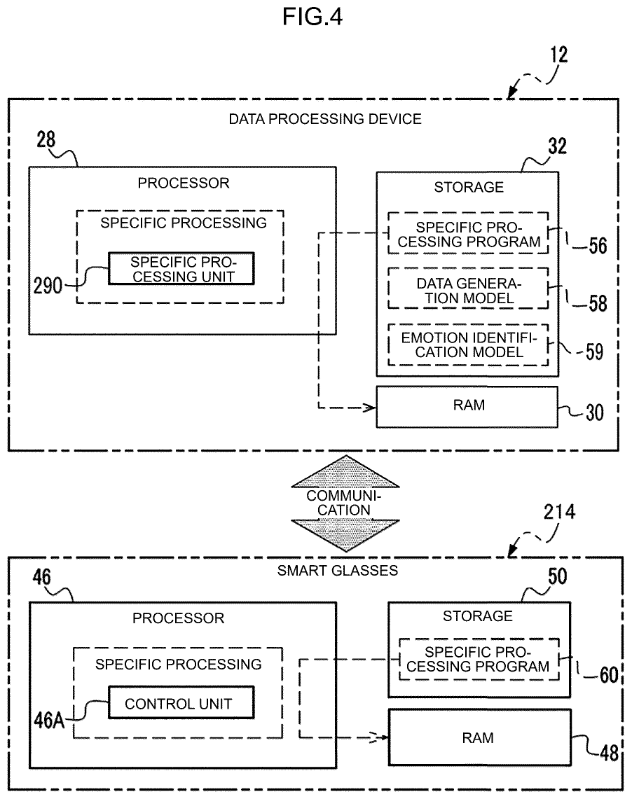

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the aforementioned elements, including the reception unit, analysis unit, proposal unit, simulation unit, monitoring unit, generation unit, and database unit, is implemented by at least one of, for example, the smart glasses 214 and the data processing apparatus 12. For example, the reception unit is implemented by a control unit 46A of the smart glasses 214 and inputs a user's status. The analysis unit is implemented, for example, by a specific processing unit 290 of the data processing apparatus 12 and analyzes input information using a generative AI. The proposal unit is implemented, for example, by the specific processing unit 290 of the data processing apparatus 12 and proposes a target task based on the analyzed information. The simulation unit is implemented, for example, by the specific processing unit 290 of the data processing apparatus 12 and simulates a post-recovery position based on the proposed target task. The monitoring unit is implemented, for example, by the control unit 46A of the smart glasses 214 and monitors the user's rehabilitation progress. The generation unit is implemented, for example, by the specific processing unit 290 of the data processing apparatus 12 and generates an appropriate target task based on past data and similar cases. The database unit is implemented, for example, by a database 24 of the data processing apparatus 12 and provides a database utilized by the generative AI when simulating post-recovery occupations and lifestyles. The correspondence between each unit and the apparatus or control unit is not limited to the examples described above and various modifications are possible.

### Third Embodiment

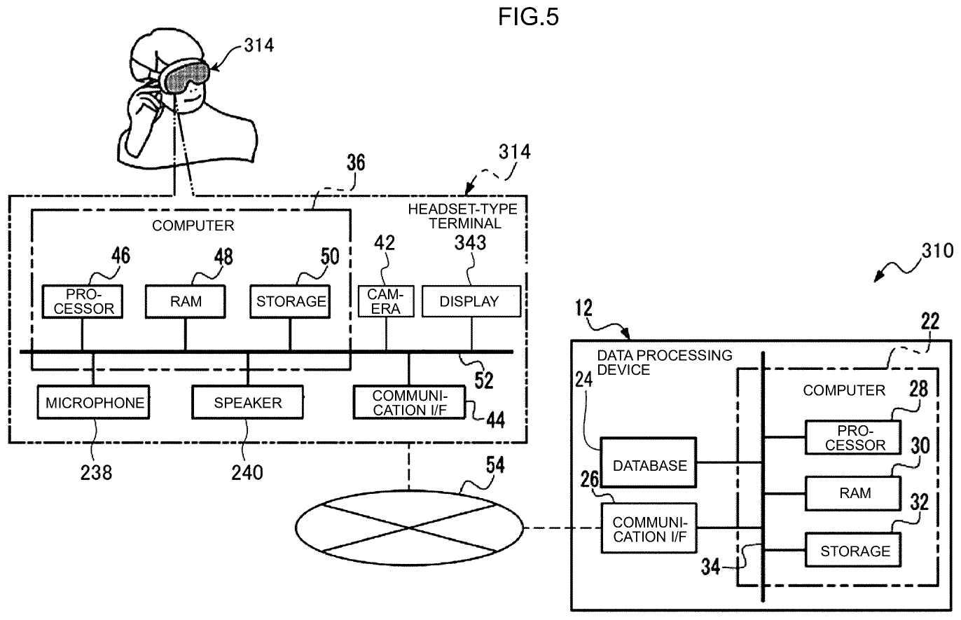

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

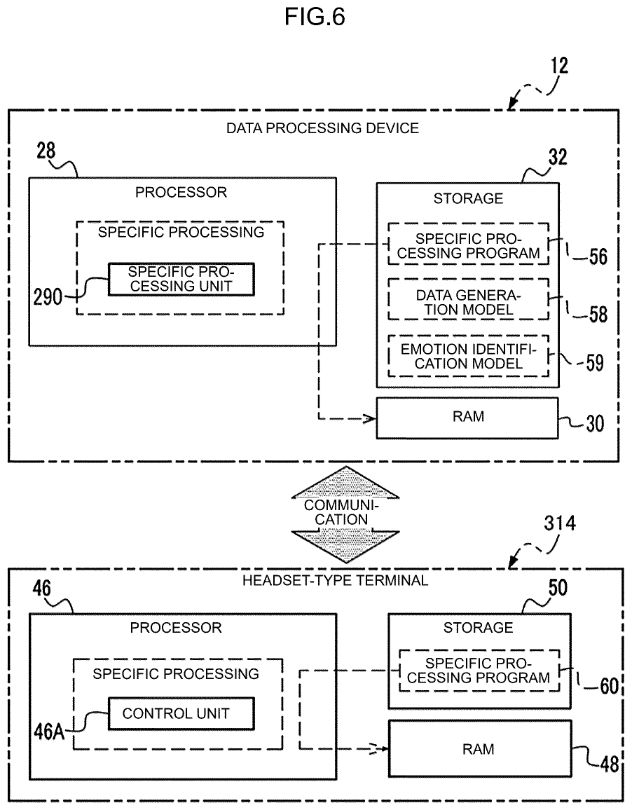

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the aforementioned elements, including the reception unit, analysis unit, proposal unit, simulation unit, monitoring unit, generation unit, and database unit, is implemented by at least one of, for example, the headset-type terminal 314 and the data processing apparatus 12. For example, the reception unit is implemented by a control unit 46A of the headset-type terminal 314 and inputs a user's status. The analysis unit is implemented, for example, by a specific processing unit 290 of the data processing apparatus 12 and analyzes input information using a generative AI. The proposal unit is implemented, for example, by the specific processing unit 290 of the data processing apparatus 12 and proposes a target task based on the analyzed information. The simulation unit is implemented, for example, by the specific processing unit 290 of the data processing apparatus 12 and simulates a post-recovery position based on the proposed target task. The monitoring unit is implemented, for example, by the control unit 46A of the headset-type terminal 314 and monitors the user's rehabilitation progress. The generation unit is implemented, for example, by the specific processing unit 290 of the data processing apparatus 12 and generates an appropriate target task based on past data and similar cases. The database unit is implemented, for example, by a database 24 of the data processing apparatus 12 and provides a database utilized by the generative AI when simulating post-recovery occupations and lifestyles. The correspondence between each unit and the apparatus or control unit is not limited to the examples described above and various modifications are possible.

### Fourth Embodiment

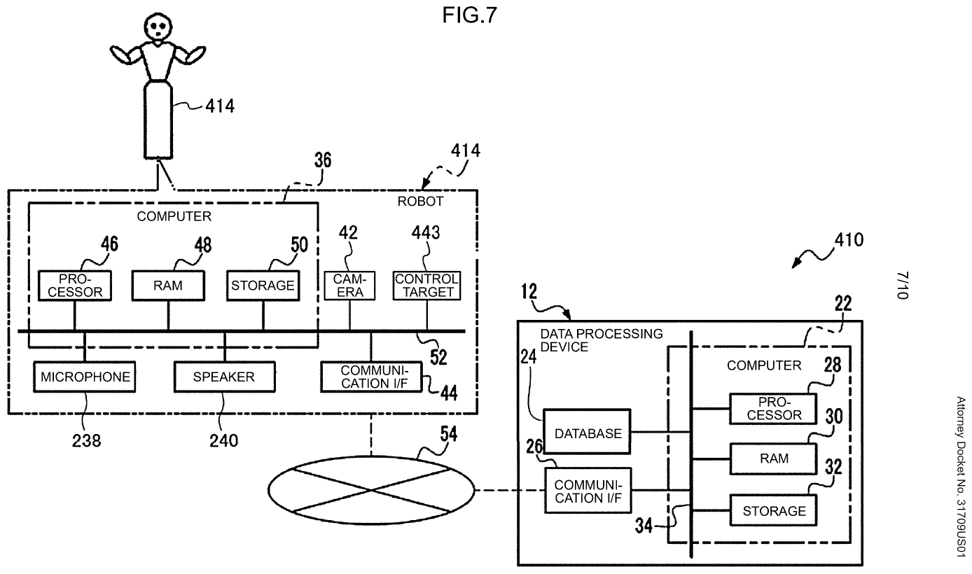

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

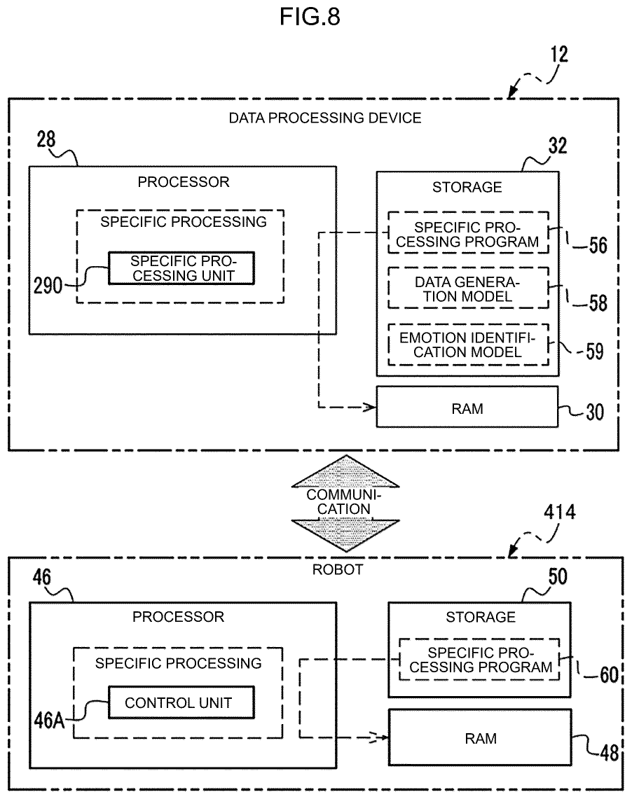

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the aforementioned elements, including the reception unit, analysis unit, proposal unit, simulation unit, monitoring unit, generation unit, and database unit, is implemented by at least one of, for example, the robot 414 and the data processing apparatus 12. For example, the reception unit is implemented by a control unit 46A of the robot 414 and inputs a user's status. The analysis unit is implemented, for example, by a specific processing unit 290 of the data processing apparatus 12 and analyzes input information using a generative AI. The proposal unit is implemented, for example, by the specific processing unit 290 of the data processing apparatus 12 and proposes a target task based on the analyzed information. The simulation unit is implemented, for example, by the specific processing unit 290 of the data processing apparatus 12 and simulates a post-recovery position based on the proposed target task. The monitoring unit is implemented, for example, by the control unit 46A of the robot 414 and monitors the user's rehabilitation progress. The generation unit is implemented, for example, by the specific processing unit 290 of the data processing apparatus 12 and generates an appropriate target task based on past data and similar cases. The database unit is implemented, for example, by a database 24 of the data processing apparatus 12 and provides a database utilized by the generative AI when simulating post-recovery occupations and lifestyles. The correspondence between each unit and the apparatus or control unit is not limited to the examples described above and various modifications are possible.

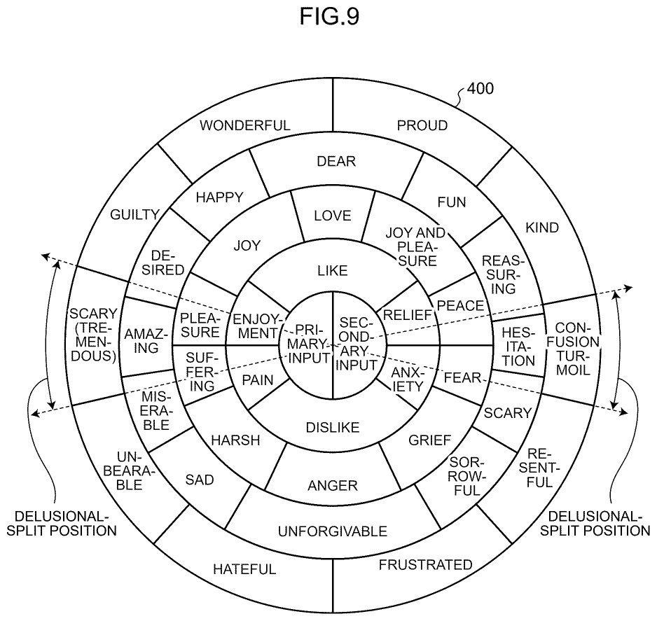

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

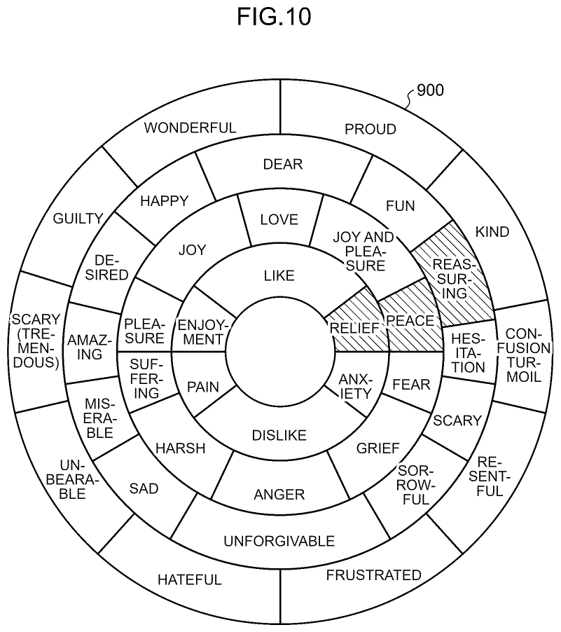

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.
(Supplementary Note 1) A system comprising: a reception unit configured to input a user's status; an analysis unit configured to analyze information input by the reception unit; a proposal unit configured to propose a target task based on information analyzed by the analysis unit; and a simulation unit configured to simulate a post-recovery state based on the target task proposed by the proposal unit.
(Supplementary Note 2) The system according to Supplementary Note 1, further comprising a monitoring unit configured to monitor the user's rehabilitation progress.
(Supplementary Note 3) The system according to Supplementary Note 1, further comprising a generation unit in which a generative AI generates an appropriate target task based on past data and similar cases.
(Supplementary Note 4) The system according to Supplementary Note 1, further comprising a database unit utilized by the generative AI when simulating post-recovery occupations and lifestyles.
(Supplementary Note 5) The system according to Supplementary Note 1, wherein the proposal unit is configured to propose an exercise program according to the progress of rehabilitation.
(Supplementary Note 6) The system according to Supplementary Note 1, wherein the simulation unit is configured to simulate post-recovery occupations and lifestyles based on the user's preferences.
(Supplementary Note 7) The system according to Supplementary Note 1, wherein the reception unit is configured to estimate the user's emotions and adjust the display method of the input interface based on the estimated emotions.
(Supplementary Note 8) The system according to Supplementary Note 1, wherein the reception unit is configured to analyze the user's past input history and propose an appropriate input method.
(Supplementary Note 9) The system according to Supplementary Note 1, wherein the reception unit is configured to customize input items at the time of input based on the user's current physical condition and psychological state.
(Supplementary Note 10) The system according to Supplementary Note 1, wherein the reception unit is configured to estimate the user's emotions and determine the priority of input based on the estimated emotions.
(Supplementary Note 11) The system according to Supplementary Note 1, wherein the reception unit is configured to preferentially display highly relevant input items at the time of input by considering the user's geographic location information.
(Supplementary Note 12) The system according to Supplementary Note 1, wherein the reception unit is configured to analyze the user's social media activity and propose relevant input items at the time of input.
(Supplementary Note 13) The system according to Supplementary Note 1, wherein the analysis unit is configured to estimate the user's emotions and adjust the analysis algorithm based on the estimated emotions.
(Supplementary Note 14) The system according to Supplementary Note 1, wherein the analysis unit is configured to refer to the user's past data during analysis to improve the accuracy of analysis.
(Supplementary Note 15) The system according to Supplementary Note 1, wherein the analysis unit is configured to customize the analysis method during analysis based on the user's current physical condition.
(Supplementary Note 16) The system according to Supplementary Note 1, wherein the analysis unit is configured to estimate the user's emotions and adjust the display method of the analysis results based on the estimated emotions.
(Supplementary Note 17) The system according to Supplementary Note 1, wherein the analysis unit is configured to improve the accuracy of analysis by considering the user's geographic location information during analysis.
(Supplementary Note 18) The system according to Supplementary Note 1, wherein the analysis unit is configured to analyze the user's social media activity and utilize relevant data in the analysis during analysis.
(Supplementary Note 19) The system according to Supplementary Note 1, wherein the proposal unit is configured to estimate the user's emotions and adjust the expression method of proposals based on the estimated emotions.
(Supplementary Note 20) The system according to Supplementary Note 1, wherein the proposal unit is configured to refer to the user's past data during proposal to improve the accuracy of proposals.
(Supplementary Note 21) The system according to Supplementary Note 1, wherein the proposal unit is configured to customize the content of proposals during proposal based on the user's current physical condition.
(Supplementary Note 22) The system according to Supplementary Note 1, wherein the proposal unit is configured to estimate the user's emotions and determine the priority of proposals based on the estimated emotions.
(Supplementary Note 23) The system according to Supplementary Note 1, wherein the proposal unit is configured to preferentially make highly relevant proposals during proposal by considering the user's geographic location information.
(Supplementary Note 24) The system according to Supplementary Note 1, wherein the proposal unit is configured to analyze the user's social media activity and make relevant proposals during proposal.
(Supplementary Note 25) The system according to Supplementary Note 1, wherein the simulation unit is configured to refer to the user's past data during simulation to improve the accuracy of simulation.
(Supplementary Note 26) The system according to Supplementary Note 1, wherein the simulation unit is configured to customize the simulation method during simulation based on the user's current physical condition.
(Supplementary Note 27) The system according to Supplementary Note 1, wherein the simulation unit is configured to estimate the user's emotions and determine the priority of simulation based on the estimated emotions.
(Supplementary Note 28) The system according to Supplementary Note 1, wherein the simulation unit is configured to preferentially perform highly relevant simulations during simulation by considering the user's geographic location information.
(Supplementary Note 29) The system according to Supplementary Note 1, wherein the simulation unit is configured to analyze the user's social media activity and perform relevant simulations during simulation.
(Supplementary Note 30) The system according to Supplementary Note 2, wherein the monitoring unit is configured to estimate the user's emotions and adjust the frequency of monitoring based on the estimated emotions.
(Supplementary Note 31) The system according to Supplementary Note 2, wherein the monitoring unit is configured to refer to the user's past data during monitoring to improve the accuracy of monitoring.
(Supplementary Note 32) The system according to Supplementary Note 2, wherein the monitoring unit is configured to estimate the user's emotions and determine the priority of monitoring based on the estimated emotions.
(Supplementary Note 33) The system according to Supplementary Note 2, wherein the monitoring unit is configured to preferentially perform highly relevant monitoring during monitoring by considering the user's geographic location information.
(Supplementary Note 34) The system according to Supplementary Note 3, wherein the generation unit is configured to estimate the user's emotions and adjust the generation algorithm based on the estimated emotions.
(Supplementary Note 35) The system according to Supplementary Note 3, wherein the generation unit is configured to refer to the user's past data during generation to improve the accuracy of generation.
(Supplementary Note 36) The system according to Supplementary Note 3, wherein the generation unit is configured to estimate the user's emotions and determine the priority of generation based on the estimated emotions.
(Supplementary Note 37) The system according to Supplementary Note 3, wherein the generation unit is configured to preferentially perform highly relevant generation during generation by considering the user's geographic location information.
(Supplementary Note 38) The system according to Supplementary Note 4, wherein the database unit is configured to estimate the user's emotions and adjust the search results of the database based on the estimated emotions.
(Supplementary Note 39) The system according to Supplementary Note 4, wherein the database unit is configured to refer to the user's past data during database update to improve the accuracy of updates.
(Supplementary Note 40) The system according to Supplementary Note 4, wherein the database unit is configured to estimate the user's emotions and determine the search priority of the database based on the estimated emotions.
(Supplementary Note 41) The system according to Supplementary Note 4, wherein the database unit is configured to preferentially update highly relevant data during database update by considering the user's geographic location information.

What is claimed is:

1. A system comprising:
circuitry configured to:
receive, from a client terminal, structured input data comprising at least one of text data, numerical time-series data, or sensor data;
generate analysis data by inputting the structured input data into a data generation model obtained by deep learning on a neural network, the analysis data comprising at least one of a classification label, a probability score, or a multidimensional feature vector;
generate inference data by inputting the analysis data into a second neural network, the inference data comprising a set of output vectors and a confidence score associated with each output vector; and
generate prediction data by inputting the inference data and parameter data received from the client terminal into a simulation model comprising a recurrent neural network, the prediction data comprising at least one of a numerical matching score or an output label, and transmit the prediction data to the client terminal.

2. The system according to claim 1, wherein the structured input data comprises status data of a user undergoing rehabilitation, the status data comprising at least one of a fracture site identifier, a treatment progress percentage, a pain level score, or a psychological state score, and wherein the inference data comprises a list of target tasks for recovery and an achievement probability score for each target task.

3. The system according to claim 1, wherein the prediction data comprises a post-recovery simulation result, the post-recovery simulation result comprising at least one of an occupational aptitude matching score, a lifestyle satisfaction prediction score, or a risk assessment value for each of a plurality of simulated scenarios.

4. The system according to claim 1, wherein the circuitry is further configured to receive, from a sensor device coupled to the client terminal, time-series sensor data comprising at least one of a walking distance value, a muscle strength measurement value, a joint range of motion value, a heart rate value, or an activity level value, collect the time-series sensor data as a two-dimensional tensor of sample count by feature count, and apply preprocessing comprising noise removal and outlier correction to the two-dimensional tensor.

5. The system according to claim 4, wherein the circuitry is further configured to input the preprocessed two-dimensional tensor into a progress evaluation model comprising at least one of a recurrent neural network or a long short-term memory network to calculate a progress score and a recovery speed prediction value, and transmit the progress score and the recovery speed prediction value to the client terminal.

6. The system according to claim 1, wherein the circuitry is further configured to retrieve reference records from a database by performing a similarity calculation between the multidimensional feature vector and stored feature vectors of the reference records, the similarity calculation comprising at least one of a cosine similarity calculation or a Euclidean distance calculation, and input the retrieved reference records into the second neural network together with the analysis data to generate the inference data.

7. The system according to claim 1, wherein the circuitry is further configured to store, in a database, structured reference data comprising occupation data and lifestyle pattern data, the occupation data comprising job type identifiers, required skill labels, and work environment descriptors, and the lifestyle pattern data comprising daily routine descriptors, family structure data, and transportation mode identifiers.

8. The system according to claim 1, wherein the inference data comprises an exercise program comprising exercise type identifiers, intensity level values, and frequency values, and wherein the circuitry is further configured to automatically adjust the intensity level values and the frequency values based on updated structured input data received from the client terminal.

9. The system according to claim 1, wherein the circuitry is further configured to estimate an emotion of a user by inputting multimodal data comprising at least one of text data, voice data, or facial image data into an emotion identification model, the emotion identification model outputting an emotion classification label and an emotion score as a probability distribution, and adjust a display parameter of a user interface rendered on the client terminal based on the emotion classification label.

10. The system according to claim 9, wherein the circuitry is further configured to adjust a parameter of the data generation model based on the emotion score, the parameter comprising at least one of an analysis depth, a number of selected features, a processing batch size, or a threshold setting.

11. The system according to claim 9, wherein the circuitry is further configured to adjust a presentation format of the inference data transmitted to the client terminal based on the emotion classification label, the presentation format comprising at least one of a number of output options, a length of an explanation text, or a color scheme identifier.

12. The system according to claim 9, wherein the circuitry is further configured to determine a priority order of a plurality of simulation scenarios based on the emotion score, and transmit the prediction data to the client terminal in the determined priority order.

13. The system according to claim 1, wherein the circuitry is further configured to retrieve, from a database, historical time-series data of the user recorded in chronological order, vectorize the historical time-series data as a sequence of 128-dimensional vectors, and input the sequence of 128-dimensional vectors into a Transformer-based time-series analysis model to extract a pattern and generate a trend prediction value.

14. The system according to claim 1, wherein the circuitry is further configured to receive, from the client terminal, physical condition data of a user comprising at least one of a fatigue score, a stress level value, or a mood score, classify the physical condition data into a state category by inputting the physical condition data into a classification model, and select a processing mode for the data generation model based on the state category.

15. The system according to claim 1, wherein the circuitry is further configured to receive location data comprising latitude and longitude coordinates from the client terminal, input the location data as a multidimensional vector into the data generation model to determine a scenario category by matching the multidimensional vector against a facility attribute database, and prioritize a subset of output items of the inference data based on the determined scenario category.

16. The system according to claim 1, wherein the circuitry is further configured to receive social media post data of a user from an external data source, tokenize and vectorize the social media post data using a natural language processing engine to generate a post feature vector, classify the post feature vector into a content category using the data generation model, and adjust a parameter of the second neural network based on the content category.

17. The system according to claim 1, wherein the circuitry is further configured to receive, from the client terminal, feedback data comprising at least one of a selection identifier, a completion rate value, or a satisfaction score, and update a parameter of at least one of the data generation model, the second neural network, or the simulation model based on the feedback data.

18. A system comprising:
circuitry configured to:
receive, from a client terminal via a communication interface coupled to a packet-switched network, structured input data comprising text data tokenized and embedded as a 512-dimensional vector, numerical time-series data formatted as a 128-dimensional feature vector, and sensor data comprising at least one of voice data converted to a spectrogram with mel-frequency cepstral coefficient features or facial image data with 68-point landmark coordinates;
generate analysis data by inputting the structured input data into a data generation model comprising a Transformer-based large language model with a self-attention mechanism, the analysis data comprising a classification label output as a probability distribution over a plurality of categories and a multidimensional feature vector;
generate inference data by performing a similarity calculation comprising at least one of a cosine similarity calculation or a Euclidean distance calculation between the multidimensional feature vector and stored reference vectors retrieved from a database, and inputting a result of the similarity calculation into a second neural network comprising at least one of a recurrent neural network or a long short-term memory network, the inference data comprising a ranked set of output vectors with a confidence score for each output vector;
estimate an emotion of a user by inputting multimodal feature data comprising the 512-dimensional vector, the mel-frequency cepstral coefficient features, and the 68-point landmark coordinates into an emotion identification model comprising a multimodal Transformer, the emotion identification model outputting an emotion classification label and an emotion score as a probability distribution over a plurality of emotion categories; and
generate prediction data by inputting the inference data, parameter data received from the client terminal, and the emotion score into a simulation model comprising a recurrent neural network, the prediction data comprising a numerical matching score, a satisfaction prediction score, and a risk assessment value for each of a plurality of simulated scenarios, and transmit the prediction data to the client terminal via the communication interface and the packet-switched network.

19. The system according to claim 18, wherein the data generation model comprises a plurality of AI models comprising at least one of a convolutional neural network configured to receive image data and output a segmentation map, a recurrent neural network configured to receive time-series data and output a trend prediction value, or a large language model configured to receive text data and output a classification label and a recommendation text.

20. A method performed by circuitry of a system, the method comprising:
receiving, from a client terminal, structured input data comprising at least one of text data, numerical time-series data, or sensor data;
generating analysis data by inputting the structured input data into a data generation model obtained by deep learning on a neural network, the analysis data comprising at least one of a classification label, a probability score, or a multidimensional feature vector;
generating inference data by inputting the analysis data into a second neural network, the inference data comprising a set of output vectors and a confidence score associated with each output vector; and
generating prediction data by inputting the inference data and parameter data received from the client terminal into a simulation model comprising a recurrent neural network, the prediction data comprising at least one of a numerical matching score or an output label, and transmitting the prediction data to the client terminal.
